(19) United States
(12) Patent Application Publication
(10) Pub. No.: US 2008/0077600 A1
(43) Pub. Date: Mar. 27, 2008

(54) INFORMATION PROCESSING APPARATUS, INFORMATION PROCESSING METHOD AND INFORMATION PROCESSING PROGRAM

(75) Inventors: Takashi Nakamura, Tokyo (JP); Seigo Kawamura, Tokyo (JP); Hirotaka Ishikawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/854,946

(22) Filed: Sep. 13, 2007

(30) Foreign Application Priority Data
Sep. 21, 2006 (JP) 2006-256503

(51) Int. Cl. G06F 7/00

(52) U.S. Cl. 707/100; 707/E17.009

(57) ABSTRACT

Disclosed herein is an information processing apparatus including: terminal registration means; sender means; receiver means; history information management means; information selection means; and user registration means.

### CROSS REFERENCES TO RELATED APPLICATIONS

The present invention contains subject matter related to Japanese Patent Application JP 2006-256503 filed in the Japan Patent Office on Sep. 21, 2006, the entire contents of which being incorporated herein by reference.

### BACKGROUND OF THE INVENTION

1. Field of the Invention

This invention relates to an information processing apparatus, an information processing method and an information processing program and is suitable for use with a case wherein, for example, a network such as the Internet or the like is used to provide information.

2. Description of the Related Art

In recent years, service for providing various information to the user utilizing a network such as the Internet or the like (a service of the type described is hereinafter referred to also as information providing service) is widely spread. As one of such information providing services as just described, a service is proposed, for example, in Japanese Patent Laid-Open No. 2002-334104. According to the service mentioned, the same information is provided to all users, and information suitable for each user is provided based on history information such as an information accessing history of the user and so forth to achieve enhancement of the quality of the service.

### SUMMARY OF THE INVENTION

Incidentally, most of information providing services of the type described, particularly of pay information providing services, change the quality and the quantity of information to be provided to the user before and after user registration.

In particular, in such an information providing service as just described, for example, part of information which can be provided is provided to a user before user registration of the user. However, all information which can be provided is provided after the user registration.

However, in such an information providing service as described above, a user who is registered as a regular user can be identified, and users before user registration may not be managed individually. Therefore, for example, where a user performs user registration, history information of the user before the user registration may not be specified. Therefore, history information before user registration may not be utilized effectively after user registration.

It is considered here that, if history information before user registration can be utilized effectively also after user registration, then information more suitable for the user can be provided.

Therefore, according to an embodiment of the present invention, it is desirable to provide an information processing apparatus, an information processing method and an information processing program which can provide information more suitable for a user than ever.

According to an embodiment of the present invention, there is provided an information processing apparatus including a terminal registration section, a sender section, a receiver section, a history information management section, an information selection section, and a user registration section. A terminal registration section configured to apply terminal identification information to a terminal connected through a network. A sender section configured to send the terminal identification information to the terminal. A receiver section configured to receive a request from the terminal together with the terminal identification information. A history information management section configured to store and manage, if the receiver section receives the information acquisition request from the terminal together with the terminal identification information, an effect that the information acquisition request is received as history information in a matched relationship with the received terminal identification information into a storage section. An information selection section configured to select information to be sent to the terminal based on the information acquisition request. A user registration section configured to register, if the receiver section receives a user registration request from the terminal together with the terminal identification information, the user identification information of a user of the terminal and store the user identification information and the terminal identification information received from the terminal in a matched relationship with each other into the storage section.

In the information processing apparatus according to an embodiment of the present invention, since terminal identification information is applied to a terminal connected to the information processing apparatus by the network, also before user registration of a user, a terminal of the user can be identified. Further, since terminal identification information and history information are stored in a matched relationship with each other, history information can be managed for individual terminals of different users also before user registration of the users. Further, since user identification information and terminal identification information are matched with each other when a user is registered as a regular user, the user identification information and the history information prior to the user registration can be matched with each other. Therefore, the history information before user registration can be utilized effectively also after user registration. Consequently, the information processing apparatus can provide information more suitable for a user than ever.

The above and other features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a configuration of an information processing apparatus which is an outline of a first embodiment of the present invention;

FIG. 2 is a block diagram showing a configuration of an information providing system which is a particular example of the first embodiment of the present invention;

FIG. 3 is a schematic diagrammatic view showing a configuration of a registration screen image;

FIG. 4 is a schematic diagrammatic view showing a configuration of providing information;

FIG. 5 is a schematic diagrammatic view showing a configuration of a detailed information search table;

FIG. 6 is a schematic diagrammatic view showing a configuration of a storage data reproduction function execution screen image;

FIG. 7 is a schematic diagrammatic view showing a configuration of a media reproduction function execution screen image;

FIGS. 8 and 9 are schematic diagrammatic views showing different configurations of a music buying function execution screen image;

FIG. 10 is a schematic diagrammatic view showing a configuration of a waiting screen image;

FIG. 11 is a schematic diagrammatic view showing a configuration of a detailed information screen image;

FIG. 12 is a schematic diagrammatic view showing a configuration of history information according to the first embodiment of the present invention;

FIGS. 13 and 14 are sequence charts showing first and second history information storage processing procedures, respectively;

FIG. 15 is a sequence chart showing part of the second history information storage processing procedure shown in FIG. 14;

FIGS. 16A and 16B are schematic diagrammatic views illustrating a matched relationship between terminal identification information and user identification information according to a second embodiment of the present invention;

FIG. 17 is a block diagram showing a configuration of an information processing apparatus according to a third embodiment of the present invention;

FIG. 18 is a schematic diagrammatic view showing a configuration of history information according to a different embodiment of the present invention; and

FIGS. 19A and 19B are schematic diagrammatic views illustrating a matched relationship between terminal identification information and user identification information according to a different embodiment of the present invention.

### DETAILED DESCRIPTION OF THE PREFERRED EMBODIMENTS

### 1. First Embodiment

### 1-1. Outline of the First Embodiment

First, an outline of an information processing apparatus according to the first embodiment of the present invention is described. It is to be noted that, after the outline is described, a particular configuration of the information processing apparatus of the first embodiment is described.

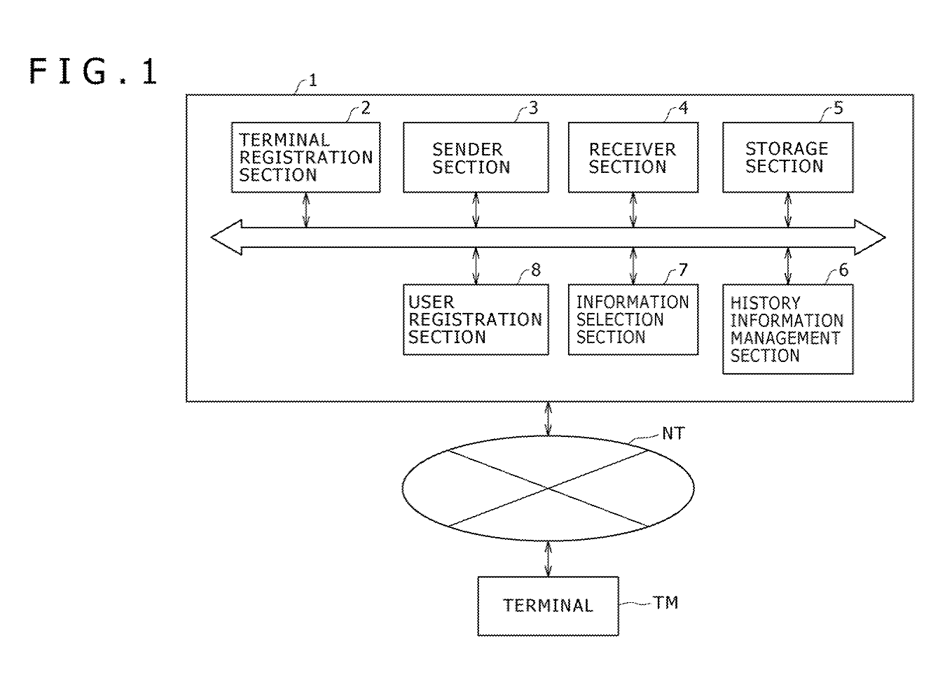

Referring first to FIG. 1, there is shown an information processing apparatus according to the first embodiment of the present invention. The information processing apparatus 1 includes a terminal registration section 2 for applying terminal identification information to a terminal TM connected thereto through a network NT, and a sender section 3 for sending the terminal identification information to the terminal TM. The information processing apparatus 1 further includes a receiver section 4 for receiving a request from the terminal TM together with terminal identification information. The information processing apparatus 1 further includes a history information management section 6 for storing and managing, if the receiver section 4 receives information acquisition request from the terminal TM together with terminal identification information, an effect that the information acquisition request is received as history information in a matched relationship with the received terminal identification information into a storage section 5. The information processing apparatus 1 further includes an information selection section 7 for selecting information to be sent to the terminal TM based on an information acquisition request. The information processing apparatus 1 further includes a user registration section 8 for registering, if the receiver section 4 receives a user registration request from the terminal TM together with terminal identification information, user identification information of a user of the terminal TM and store the user identification information in a matched relationship with the terminal identification information received from the terminal TM into the storage section 5.

In this manner, the information processing apparatus 1 can apply terminal identification information to any terminal TM connected thereto through the network NT such that the terminal TM of any user can be identified also before the user performs user registration thereof. Further, the information processing apparatus 1 can store terminal identification information and history information in a matched relationship with each other such that the history information can be managed for each user terminal TM also before user registration. Further, the information processing apparatus 1 can match the user identification information and the terminal identification information with each other when the user registration is performed such that the user identification information and the history information before user registration can be matched with each other. Therefore, the history information before user registration can be utilized effectively also after user registration.

### 1-2. Particular Configuration of the First Embodiment

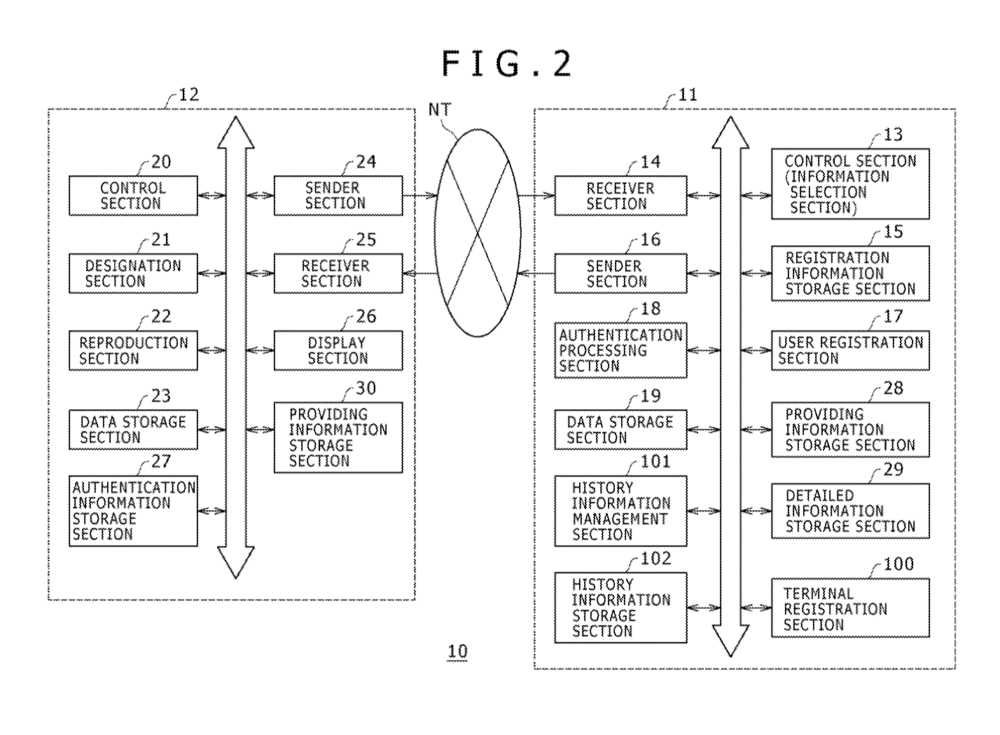

Now, a particular configuration of the information processing apparatus 1 of the first embodiment is described. Referring to FIG. 2, there is shown an information providing system 10 in which an information processing apparatus to which the present invention is applied. The information providing system 10 includes an information providing apparatus 11 for providing various kinds of information and an information presentation terminal 12 for presenting information provided from the information providing apparatus 11 through a network NT to a user. It is to be noted that the information providing apparatus 11 which composes the information providing system 19 is a particular example of the information processing apparatus 1 described above, and the information presentation terminal 12 is a particular example of the terminal TM described above.

The information providing apparatus 11 includes a control section 13 for controlling the entire apparatus and executing various processes. Consequently, the information providing apparatus 11 can provide a music data distribution service for distributing, for example, music data for a charge or free of charge to the information presentation terminal 12 of a user who has a contract with a management undertaker of the information providing system 10 (such user is hereinafter referred to as regular user) to perform user registration.

Further, the information providing apparatus 11 can provide also various services such as a sales service for selling media such as a CD (Compact Disc), a DVD (Digital Versatile Disc) and so forth through the information presentation terminal 12 to the regular user. Further, if charging is occurred by purchase of music data or a media or the like as a result of provision of a service to a regular user through the information presentation terminal 12, then the information providing apparatus 11 can execute also an accounting process for the regular user.

In an actual case, if a user registration request is sent from the information presentation terminal 12 of a user who has no user registration through the network NT (such user is hereinafter referred to as unregistered user), then the control section 13 of the information providing apparatus 11 receives the user registration request through the receiver section 14.

Here, data of a registration screen image (such data is hereinafter referred to also as registration screen image data) utilized when an unregistered user performs user registration is stored in a matched relationship with information (for example, a URL (Uniform Resource Locator); hereinafter referred to also as registered screen image link information) which indicates an acquisition destination of the registration screen image data in the registration information storage section 15 of the information providing apparatus 11. If the user registration request is received, then the control section 13 of the information providing apparatus 11 reads out the registration screen image link information from the registration information storage section 15 and sends the read out data from the sender section 16 to the information presentation terminal 12 through the network NT.

If an acquisition request for registration screen image data is sent from the information presentation terminal 12 through the network NT based on the registration screen image link information in response to the sending of the registration screen image link information, then the control section 13 of the information providing apparatus 11 receives the acquisition request through the receiver section 14.

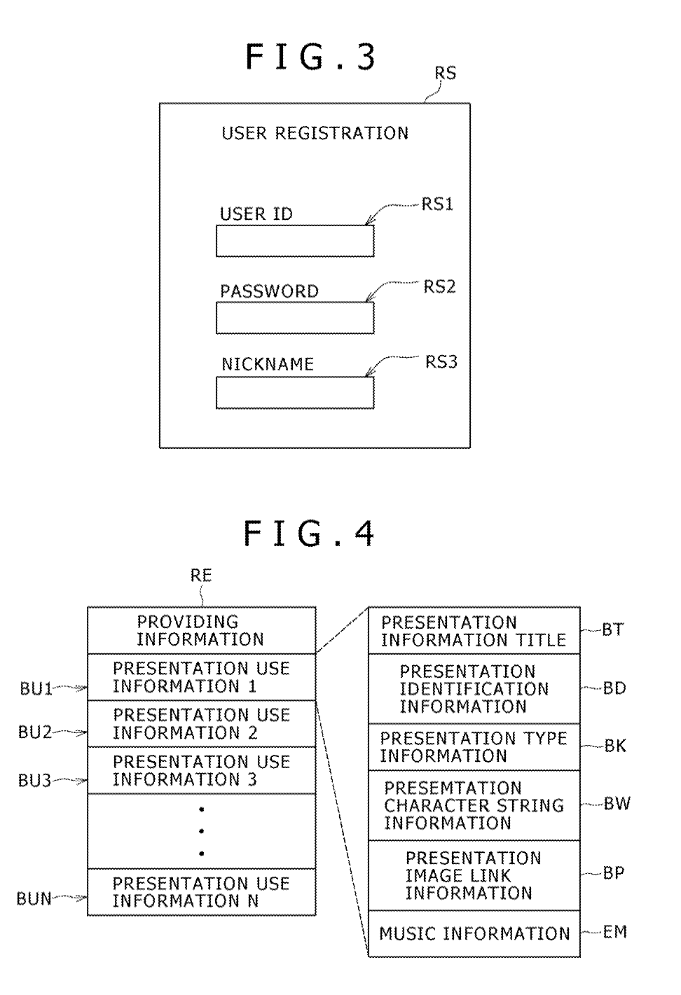

Then, the control section 13 reads out the registration screen image data from the registration information storage section 15 in accordance with the acquisition request and sends the read out data from the sender section 16 to the information presentation terminal 12 through the network NT. As a result, a registration screen image RS based on the registration screen image data is displayed on the information presentation terminal 12 as seen in FIG. 3.

On the registration screen image RS, a user identification information inputting place RS1 for urging an unregistered user to input user identification information, a password inputting place RS2 for urging the user to input a password, and a nickname inputting place RS3 for urging the user to input a nickname to be applied to the information presentation terminal 12.

If user identification information, a password and a nickname are inputted by the unregistered user through the registration screen image RS and are sent as user registration information from the information presentation terminal 12 through the network NT, then the control section 13 of the information providing apparatus 11 receives the user registration information through the receiver section 14 and sends the information to the user registration section 17. The user registration section 17 stores the user registration information into the registration information storage section 15. As a result, the user (unregistered user) of the information presentation terminal 12 is registered as a regular user.

It is to be noted that, if at least the user identification information from within the user registration information sent from the information presentation terminal 12 is stored already in the registration information storage section 15 (in particular, if the user identification information is already utilized as user identification information of a different user), then the user registration section 17 issues a notification of an effect that the user identification information is utilized as user identification information of a different user to the control section 13.

Then, the control section 13 issues a notification of an effect that the user registration is not permitted with the user registration information formerly sent thereto to the information presentation terminal 12 so as to urge the unregistered user to input different user identification information, password and nickname through the registration screen image RS. Then, if newly inputted user identification information, password and nick name are sent as new user registration information from the information presentation terminal 12 through the network NT, then the control section 13 of the information providing apparatus 11 receives the new user registration information through the receiver section 14 and sends the information to the user registration section 17 so that the user (unregistered user) of the information presentation terminal 12 is registered as a regular user.

In this manner, the user registration section 17 performs user registration using user identification information, password and nickname unique to each user.

Then, if the user registration by the user registration section 17 completes, then the control section 13 of the information providing apparatus 11 issues a user registration completion notification from the sender section 16 to the information presentation terminal 12 through the network NT. When the user registration completion notification is received, the information presentation terminal 12 automatically stores the nickname of the user registration information. It is to be noted that the information presentation terminal 12 stores the user identification information and password of the user registration information in response to an operation of the user.

Further, an authentication processing section 18 is provided in the information providing apparatus 11 and performs an authentication process for authenticating whether or not the information presentation terminal 12 is a terminal of a regular user based on the user registration information. In an actual case, if it is authenticated as a result of the authentication process that the information presentation terminal 12 from which a request for utilization of a service is a terminal of a regular user, then the authentication processing section 18 issues authentication identification information for identifying the authentication.

To the authentication identification information, a predetermined validation period with regard to a point of time at which the information is issued is set, and the authentication processing section 18 temporarily stores the authentication identification information into the registration information storage section 15 and keeps it until the validation period of the information expires.

Further, the control section 13 sends the authentication identification information issued from the authentication processing section 18 from the sender section 16 to the information presentation terminal 12 through the network NT and causes also the information presentation terminal 12 to temporarily store the authentication identification information.

When the information presentation terminal 12 utilizes various services provided from the information providing apparatus 11, if authentication identification information is temporarily stored at this time, then the information presentation terminal 12 sends a service utilization request to which the authentication identification information is added to the information providing apparatus 11 through the network NT. However, if the authentication identification information is not temporarily stored, then the information presentation terminal 12 sends a service utilization request to which no authentication identification information is added to the information providing apparatus 11 through the network NT.

If a service utilization request is sent from the information presentation terminal 12 to the information providing apparatus 11 through the network NT, then the control section 13 of the information providing apparatus 11 receives this through the receiver section 15 and sends the received request to the authentication processing section 18. If the received service utilization request has authentication identification information added thereto, then the authentication processing section 18 compares this with the authentication identification information temporarily stored in the registration information storage section 15 to perform an authentication process for the information presentation terminal 12.

Here, if the authentication identification information added to the service utilization request coincides with any of authentication identification information, whose validation period does not expire, temporarily stored in the registration storage section 15, then it is decided by the authentication processing section 18 that the authentication identification information applied to the service utilization request is effective information whose validation period does not expire. Thus, it is authenticated by the authentication processing section 18 that the information presentation terminal 12 is a terminal of a regular user.

On the other hand, if the authentication identification information added to the service utilization request does not coincide with any authentication identification information, whose validation period do not expire, temporarily stored in the registration information storage section 15, then it is decided by the authentication processing section 18 that the authentication identification information applied to the service utilization request is ineffective information whose validation period expires already. Thus, the authentication processing section 18 sends an effect that the authentication results in failure (authentication error) to the control section 13. Further, also in a case wherein authentication identification information is not added to the service utilization request, the authentication processing section 18 issues a notification of authentication error to the control section 13.

When the notification of authentication error is received from the authentication processing section 18, the control section 13 sends authentication error notification information from the sender section 16 to the information presentation terminal 12 through the network NT.

When the authentication error notification information is sent from the information providing apparatus 11 to the information presentation terminal 12, if the user registration is completed already at this time, then the information presentation terminal 12 sends an authentication request to which the user registration information (at least the nickname) stored in the terminal itself is added to the information providing apparatus 11 through the network NT.

On the other hand, if the user registration is not yet completed at this time, then the information presentation terminal 12 sends an authentication request to which user registration information is not added to the information providing apparatus 11 through the network NT.

When the authentication request sent from the information presentation terminal 12 is received through the receiver section 14 after the authentication error notification information is sent, the control section 13 of the information providing apparatus 11 sends this to the authentication processing section 18. The authentication processing section 18 confirms first whether or not user registration information is added to the received authentication request. If the authentication request has user registration information added thereto, then the authentication processing section 18 performs the authentication process for the information presentation terminal 12 again wherein the user registration information added to the authentication request and the user registration information stored in the registration information storage section 15 are compared with each other.

Here, if the user registration information sent from the information presentation terminal 12 coincides with some of the user registration information stored in the registration information storage section 15, then it is authenticated by the authentication processing section 18 that the information presentation terminal 12 is a terminal of a regular user.

If it is authenticated in this manner that the information presentation terminal 12 is a terminal of a regular user, then the authentication processing section 18 issues authentication identification information and temporarily stores the issued information into the registration information storage section 15 and then retains it until the validation period of the information expires.

On the other hand, if the user registration information sent from the information presentation terminal 12 does not coincide with any of the user registration information stored in the registration information storage section 15, then it is decided by the authentication processing section 18 that the information presentation terminal 12 is not a terminal of a regular user. Then, the authentication processing section 18 sends back the result of the decision (authentication error) to the control section 13. Then, the control section 13 controls, for example, the receiver section 14 and the sender section 16 to cut the communication connection between the information providing apparatus 11 and the information presentation terminal 12. Consequently, the information providing apparatus 11 prevents illegal utilization of services through the information presentation terminal 12 by an unregistered user.

Further, also in a case wherein user registration information is not applied to an authentication request, the authentication processing section 18 of the information providing apparatus 11 sends this (authentication error) to the control section 13. Then, the control section 13 decides that a utilization request for services is sent from an unregistered user through the information presentation terminal 12, and reads out the registration screen image link information from the registration information storage section 15 and sends the read out information from the sender section 16 to the information presentation terminal 12 through the network NT.

In this manner, if a request for utilization of a service is issued from the information presentation terminal 12 of an unregistered user, then the information providing apparatus 11 urges the unregistered user to perform user registration.

The information providing apparatus 11 further includes a data storage section 19 in which a large number of music data to be provided, attribute information of the music data and link information (such information is hereinafter referred to as data attribute information) indicative of acquisition destinations of the music data are stored in a matched relationship with each other.

Incidentally, a piece of the data attribute information includes a title of music (hereinafter referred to music title) based on corresponding music data, a name of an artist (hereinafter referred to as artist name), and a name of an album (hereinafter referred to as album name) in which the music is collected. The data attribute information further includes reproduction time, and information indicative of an acquisition destination of data of an image of a jacket of the album in which the music is collected (such data is hereinafter referred to as jacket image data). Such information indicative of an acquisition designation typically is a URL and is hereinafter referred to as image link information.

Also data of a music introduction screen image (hereinafter referred to also as music introduction screen image data) for introducing music data to be purchased and data of a music purchase screen image (hereinafter referred to also as music purchase screen image data) for allowing music data to be purchased are stored in the data storage section 19. Such music introduction screen image data and music purchase screen image data are stored in a matched relationship with link information indicative of an acquisition destination of the screen image data.

Also various screen image data to be utilized for provision of various services are stored in the data storage section 19 in a matched relationship with link information indicative of an acquisition destination of the screen image data. The screen image data include data of a media introduction screen image (hereinafter referred to as media introduction screen image data) for introducing media to be purchased and data of a media purchase screen image (hereinafter referred to as media purchase screen image data) for allowing media to be purchased.

Therefore, if the information presentation terminal 12 which issues a request for utilization of a service is authenticated by the authentication processing section 18, then the control section 13 of the information providing apparatus 11 reads out link information matched with the screen image data corresponding to the type of the requested service from the data storage section 19. The control section 13 sends the link information from the sender section 16 to the information presentation terminal 12 through the network NT.

Incidentally, if the information presentation terminal 12 is authenticated with authentication identification information, then the control section 13 sends the link information as it is from the sender section 16 to the information presentation terminal 12 through the network NT. However, if the information presentation terminal 12 is authenticated with user registration information, then the control section 13 sends the link information together with the authentication identification information issued upon such authentication from the sender section 16 to the information presentation terminal 12 through the network NT.

If authentication identification information is received from the link information, then the information presentation terminal 12 temporarily stores the received information. At this time, if past authentication identification information is temporarily stored already, then the information presentation terminal 12 temporarily stores the new authentication identification information in an overwriting fashion. Consequently, in a normal state, the information presentation terminal 12 temporarily stores one piece of authentication identification information which has the latest issuance date or the longest period of validity.

If, for example, an acquisition request for music introduction screen image data is received from the authenticated information presentation terminal 12 based on the link information through the network NT, then the control section 13 of the information providing apparatus 11 receives the acquisition request through the receiver section 14. Then, the control section 13 reads out corresponding music instruction screen image data from the data storage section 19 in accordance with the acquisition request and sends the read out music instruction screen image data from the sender section 16 to the information presentation terminal 12 through the network NT. As a result, a music introduction screen image based on the music instruction screen image data is displayed on the information presentation terminal 12, and music data to be purchased by a regular user are introduced through the screen image.

In addition, in the music instruction screen image data and the media introduction screen image data, link information indicative of an acquisition destination of data of a music purchase screen image (hereinafter referred to also as music purchase screen image data) and data of a media purchase screen image (hereinafter referred to also as media purchase screen image data) for allowing a plurality of music data or a plurality of media, which are introduced through such screen images, to be purchased is embedded in a matched relationship with the music data and the media to be introduced.

Therefore, if desired music data or a desired media is selected by a regular user through the music instruction screen image or the media introduction screen image displayed on the information presentation terminal 12, then the information presentation terminal 12 extracts link information of music purchase screen image data or media purchase screen image data matched with the selected music data or media. Then, the information presentation terminal 12 sends an acquisition designation of the music purchase screen image data or media purchase screen image data based on the link information to the information providing apparatus 11 through the network NT.

If an acquisition request for music purchase screen image data or media purchase screen image data is sent from the information presentation terminal 12 through the network NT, then the control section 13 of the information providing apparatus 11 receives the acquisition request through the receiver section 14. Then, the control section 13 reads out music purchase screen image data or media purchase screen image data matched with the data storage section 19 in accordance with the acquisition request and sends the read out screen image data from the sender section 16 to the information presentation terminal 12 through the network NT.

As a result, a music purchase screen image based on the music purchase screen image data or a media purchase screen image based on the media purchase screen image data is displayed on the information presentation terminal 12. Thus, various kinds of information relating to purchase of music data or media by a regular user is inputted through the music purchase screen image or media purchase screen image.

Link information indicative of an acquisition destination of music data to be purchased through a music purchase screen image is embedded in the music purchase screen image data. Therefore, if various kinds of information relating to purchase of desired music data is inputted by a regular user through the music purchase screen image, then the information presentation terminal 12 extracts the link information of music data to be purchased from the music purchase screen image data.

The information presentation terminal 12 produces a distribution request for desired music data based on various kinds of information inputted by the regular user. Then, the information presentation terminal 12 sends the distribution request for music data based on link information of the music data to be purchased to the information providing apparatus 11 through the network NT.

If a distribution request for music data is sent from the information presentation terminal 12 based on link information through the network NT, then the control section 13 of the information providing apparatus 11 receives the distribution request through the receiver section 14. Then, the control section 13 reads out corresponding music data and data attribute information in accordance with the distribution request from the data storage section 19 and sends the read out music data and data attribute information from the sender section 16 to the information presentation terminal 12 through the network NT. Further, the control section 13 of the information providing apparatus 11 executes also an accounting process for the regular user in response to the music data distributed to the information presentation terminal 12 at this time.

If various kinds of information relating to desired media is inputted through the music purchase screen image by the user, then the information presentation terminal 12 produces a purchase request for the desired media based on the inputted information. Then, the information presentation terminal 12 sends the purchase request information for the media to the information providing apparatus 11 through the network NT.

When the purchase request for the media is sent from the information presentation terminal 12 through the network NT, the control section 13 of the information providing apparatus 11 receives the purchase request through the receiver section 14. Then, the control section 13 executes an accounting process for the regular user in response to the purchase request and performs a process for the arrangement so that the purchase requested media should be distributed to the regular user.

In this manner, the information providing apparatus 11 can provide various services such as a music data distribution service and a commodity sales service to regular users.

Incidentally, if the information providing apparatus 11 is accessed by the information presentation terminal 12 of an unregistered user, then the control section 13 thereof reads out data of one or a plurality of service introduction screen images (hereinafter referred to as service introduction screen image data) stored in advance in the registration information storage section 15. Then, the control section 13 sends the read out service introduction screen image data from the sender section 16 to the information presentation terminal 12 through the network NT.

As a result, one or a plurality of service introduction screen images based on the service introduction screen image data are displayed on the information presentation terminal 12. In this manner, the information providing apparatus 11 urges an unregistered user to perform user registration by introducing various services which can be provided by the information providing apparatus 11 to the user through the service introduction screen image or images.

Meanwhile, the information presentation terminal 12 is configured such that the control section 20 thereof controls the entire information presentation terminal 12 and executes various processes in response to various instructions inputted from a remote controller (not shown) or the designation section 21 having a plurality of operation keys provided on a housing. Consequently, the information presentation terminal 12 can implement various functions such as a media reproduction function of reproducing music data from a media such as a CD loaded therein, a recording function of recording music data recorded on a media, a music purchasing function of purchasing music data from the information providing apparatus 11, and a storage data reproduction function of reproducing music data stored by recording or purchase.

In particular, if a media reproduction function selection instruction for selecting the media reproduction function is inputted by an operation of the designation section 21 by the user, then the control section 20 of the information presentation terminal 12 activates the media reproduction function. In this instance, the control section 20 reproduces music data stored in a media loaded therein through the reproduction section 22 to output the music data as music. Consequently, the information presentation terminal 12 can allow the user to enjoy the music based on the music data reproduced from the media.

If a recording function selection instruction for selecting the recording function is inputted by an operation of the designation section 21 by the user, then the control section 20 of the information presentation terminal 12 activates the recording function. In this instance, the control section 20 reads out music data from a media loaded therein and compression codes the music data in accordance with a predetermined compression coding system by means of the reproduction section 22. Then, the control section 20 signals the compression coded music data to the data storage section 23. As a result, the music data compression coded in accordance with the compression coding system are stored into the data storage section 23.

Incidentally, upon such recording, the control section 20 issues a request for data attribute information of the music data to be recorded to an external attribute information providing apparatus (not shown) through the sender section 24. If data attribute information is sent from the attribute information providing apparatus in accordance with the request for data attribute information, then the control section 20 receives the data attribute information through the receiver section 25 and signals the data attribute information to the data storage section 23. Consequently, the data attribute information is stored in a matched relationship with the recorded music data into the data storage section 23.

Further, if a storage data reproduction function selection instruction for selecting the storage data reproduction function is inputted by an operation of the designation section 21 by the user, then the control section 20 of the information presentation terminal 12 activates the storage data reproduction function. In this instance, the control section 20 reads out music data designated by the user from the data storage section 23 and reproduces (including decoding) the music data by means of the reproduction section 22 to output the music data as music. Consequently, the information presentation terminal 12 can allow the user to enjoy the music based on the music data stored in the data storage section 23.

In this manner, the information presentation terminal 12 can implement the media reproduction function, recording function and storage data reproduction function without relying upon presence or absence of a user registration.

Incidentally, in order for the information presentation terminal 12 to implement the music purchasing function, it is necessary for the user of the information presentation terminal 12 itself to have a user registration in the information providing apparatus 11. In particular, if a user registration request instruction for requesting for user registration is inputted by an operation of the designation section 21 by an unregistered user, then a user registration request is sent from the sender section 24 to the information providing apparatus 11 through the network NT in response to the input of the user registration request instruction.

If registration screen image link information is sent from the information providing apparatus 11 through the network NT in response to the user registration request, then the control section 20 of the information presentation terminal 12 receives the registration screen image link information through the receiver section 25. Then, the control section 20 sends an acquisition request for registration screen data from the sender section 24 to the information providing apparatus 11 through the network NT based on the received registration screen image link information.

If registration screen image data is sent from the information providing apparatus 11 to the information presentation terminal 12 through the network NT in response to the sending of the acquisition request for registration screen image data, then the control section 20 of the information presentation terminal 12 receives the registration screen image data through the receiver section 25 and sends the registered screen image data to the display section 26. Consequently, the display section 26 displays a registration screen image RS (FIG. 3) based on the registration screen image data.

If user identification information, a password and a nickname are inputted by an operation of the designation section 21 by an unregistered user through the registration screen image RS, then the control section 20 of the information presentation terminal 12 sends the inputted information as user registration information from the sender section 24 to the information providing apparatus 11 through the network NT.

If a user registration completion notification indicative of an effect that user registration is completed, that is, that the user is registered as a regular user, is sent from the information providing apparatus 11 through the network NT in response to the sending of the user registration information, then the control section 20 of the information presentation terminal 12 receives the user registration completion notification through the receiver section 25. Then, the control section 20 automatically stores the nickname inputted formerly through the registration screen image RS into the authentication information storage section 27. Further, the control section 20 sends the user registration completion notification to the display section 26. Consequently, the display section 26 displays thereon an effect that the user registration is completed, that is, that the user is registered as a regular user.

Further, if a request for storage of the user identification information and the password is issued thereupon through the designation section 21 by the user, that is, the regular user, then the control section 20 stores also the user identification information and the password inputted through the registration screen image RS formerly into the authentication information storage section 27.

Incidentally, if authentication identification information issued in response to authentication of the information presentation terminal 12 is sent from the information providing apparatus 11 through the network NT, then the control section 20 of the information presentation terminal 12 receives the authentication identification information through the receiver section 25 and temporarily stores the authentication identification information into the authentication information storage section 27. It is to be noted that, if past authentication identification information is temporarily stored in the authentication information storage section 27 already, then the control section 20 of the information presentation terminal 12 temporarily stores the new authentication identification information in an overwriting relationship with the past authentication identification information. In other words, in a normal state, the information presentation terminal 12 temporarily stores the latest authentication identification information sent thereto from the information providing apparatus 11.

Then, if a music purchase function selection instruction for selecting the music purchase function is inputted by an operation of the designation section 21 by the regular user, then the control section 20 of the information presentation terminal 12 activates the music purchase function. In this instance, the control section 20 confirms whether or not authentication identification information is temporarily stored in the authentication information storage section 27. If authentication identification information is temporarily stored in the authentication information storage section 27, then the control section 20 sends a service utilization request to which the authentication identification information is added from the sender section 24 to the information providing apparatus 11 through the network NT. On the other hand, if authentication identification information is not temporarily stored in the authentication information storage section 27, then the control section 20 sends a service utilization request to which no authentication identification information is added from the sender section 24 to the information providing apparatus 11 through the network NT.

If link information of music introduction screen image data as a result of authentication of the information presentation terminal 12 with the authentication identification information added to the service utilization request is sent from the information providing apparatus 11 in response to the sending of the service utilization request, then the control section 20 of the information presentation terminal 12 receives the link information through the receiver section 25.

On the other hand, if authentication error notification information is sent from the information providing apparatus 11 through the network NT as a result of failure in authentication of the information presentation terminal 12 with the authentication identification information to which the service utilization request is added, for example, because the term of validity of the authentication identification information has expired already, then the control section 20 of the information presentation terminal 12 receives the authentication error notification information through the receiver section 25.

Further, if authentication error notification information is sent from the information providing apparatus 11 through the network NT because of lack of addition of authentication identification information to the service utilization request, then the control section 20 of the information presentation terminal 12 receives the authentication error notification information through the receiver section 25.

Here, if such authentication error notification information is received, then the control section 20 of the information presentation terminal 12 confirms whether or not a nickname is stored in the authentication information storage section 27. Then, if a nickname is stored in the authentication information storage section 27, then the control section 20 confirms whether or not also user identification information and a password are stored in the authentication information storage section 27.

If all of a nickname, user identification information and a password are stored in the authentication information storage section 27, then the control section 20 of the information presentation terminal 12 sends an authentication request to which all of such information are added from the sender section 24 to the information providing apparatus 11 through the network NT.

On the other hand, if a nickname is not stored in the authentication information storage section 27, then the control section 20 of the information presentation terminal 12 urges the regular user to input user identification information and a password, for example, through the display section 26. If user identification information and a password are inputted in response to the urging through the designation section 21 by the regular user, then the control section 20 sends an authentication request to which the received information and the nickname stored in the authentication information storage section 27 are added from the sender section 24 to the information providing apparatus 11 through the network NT.

If link information of authentication identification information and music introduction screen image data are sent from the information providing apparatus 11 through the network NT as a result of authentication of the information presentation terminal 12 with the user registration information added to the authentication request from the information providing apparatus 11 in response to the sending of the authentication request to which the user identification information and the password are added, that is, the authentication request to which the user registration information is added, then the control section 20 of the information presentation terminal 12 receives the information from the information providing apparatus 11 through the receiver section 25. Then, the control section 20 temporarily stores the authentication identification information from within the received information into the authentication information storage section 27.

Then, the control section 20 of the information presentation terminal 12 sends an acquisition request for music introduction screen image data from the sender section 24 to the information providing apparatus 11 through the network NT based on the link information obtained as a result of the authentication of the information presentation terminal 12 from the information providing apparatus 11.

Then, if music introduction screen image data is sent from the information providing apparatus 11 through the network NT in response to the acquisition request, then the control section 20 of the information presentation terminal 12 receives the music introduction screen image data through the receiver section 25 and sends the music introduction screen image data to the display section 26. Consequently, the display section 26 displays a music instruction screen image based on the music introduction screen image data.

If the designation section 21 is operated by the regular user to select desired music data through the music introduction screen image, then the control section 20 of the information presentation terminal 12 extracts link information of the music purchase screen image data matched with the selected music data from within the media purchase screen image data. Then, the control section 20 sends an acquisition request for media purchase screen image data based on the link information from the sender section 24 to the information providing apparatus 11 through the network NT.

If media purchase screen image data is sent from the information providing apparatus 11 through the network NT in response to the sending of the acquisition request for media purchase screen image data, then the control section 20 of the information presentation terminal 12 receives the media purchase screen image data through the receiver section 25 and sends the media purchase screen image data to the display section 26. Consequently, the display section 26 displays a media purchase screen image based on the media purchase screen image data.

Then, if the user various kinds of information relating to purchase of the desired music data is inputted through the designation section 21 on the media purchase screen image, then the control section 20 of the information presentation terminal 12 produces a distribution request for desired music data based on the input information. Further, the control section 20 extracts link information of the music data to be purchased from the sender section 24 to the information providing apparatus 11 through the network NT.

If music data and data attribute information are sent from the information providing apparatus 11 through the network NT in response to the sending of the distribution request for music data, then the control section 20 of the information presentation terminal 12 receives the information sent from the information providing apparatus 11 through the receiver section 25 and sends the received information to the data storage section 23. Consequently, the received music data and the data attribute information of the received music data are stored in a matched relationship with each other into the data storage section 23.

In this manner, the information presentation terminal 12 can receive purchased music data from the information providing apparatus 11 and store the received music data into the data storage section 23. Further, the music data stored in the data storage section 23 can thereafter be reproduced freely by the storage data reproduction function.

If a service utilization request instruction for requesting utilization of the item sales service is inputted in response to an operation of the designation section 21 by the regular user, then the control section 20 of the information presentation terminal 12 establishes communication connection to the information providing apparatus 11.

Then, if the information presentation terminal 12 is authenticated in a similar manner as upon activation of the music purchase function described hereinabove by the information providing apparatus 11, then the control section 20 acquires link information of the media instruction screen image data. Then, the control section 20 sends an acquisition request for media instruction screen image data from the sender section 24 to the information providing apparatus 11 through the network NT based on the received link information.

If media introduction screen image data is sent from the information providing apparatus 11 through the network NT in response to the sending of the acquisition request for media introduction screen image data, then the control section 20 of the information presentation terminal 12 receives the media introduction screen image data through the receiver section 25 and sends the received media introduction screen image data to the display section 26. Consequently, the display section 26 displays a media introduction screen image based on the media introduction screen image data.

If a desired media is selected through the designation section 21 by the regular user on the media instruction screen image, then the control section 20 of the information presentation terminal 12 extracts link information of the media purchase screen image data matched with the selected media from within the media instruction screen image data. Then, the control section 20 sends an acquisition request for media purchase screen image data from the sender section 24 to the information providing apparatus 11 through the network NT based on the extracted link information.

If media purchase screen image data is sent from the information providing apparatus 11 through the network NT in response to the sending of the acquisition request for the media purchase screen image data, then the control section 20 of the information presentation terminal 12 receives the media purchase screen image data through the receiver section 25 and sends the received media purchase screen image data to the display section 26. Consequently, the display section 26 displays a media purchase screen image based on the media purchase screen image data.

If various kinds of information relating to the purchase of the desired media is inputted through the designation section 21 by the regular user on the media purchase screen image, then the control section 20 of the information presentation terminal 12 produces a purchase request for a desired media based on the inputted information. Then, the control section 20 sends the purchase request from the sender section 24 to the information providing apparatus 11 through the network NT. Consequently, the information presentation terminal 12 can allow the regular user to utilize the commodity sales service to purchase the desired media.

In this manner, the information presentation terminal 12 can allow the regular user to utilize various services such as the music data distribution service and the commodity sales service provided from the information providing apparatus 11.

Incidentally, if the control section 20 of the information presentation terminal 12 receives a request for utilization of the various services such as the music data distribution service and the commodity sales service from an unregistered user, then since authentication identification information is not stored in the authentication information storage section 27, the control section 20 sends a service utilization request to which authentication identification information is not added from the sender section 24 to the information providing apparatus 11 through the network NT.

As a result, authentication error notification information is sent from the information providing apparatus 11 to the information presentation terminal 12. Consequently, the control section 20 of the information presentation terminal 12 receives the authentication error notification information and then confirms whether or not a nickname is stored in the authentication information storage section 27.

In this instance, since user registration is not completed as yet, no nickname is stored in the authentication information storage section 27. Therefore, the control section 20 of the information presentation terminal 12 sends an authentication request to which a nickname is not added from the sender section 24 to the information providing apparatus 11 through the network NT.

As a result, since user registration is not completed as yet, registration screen image link information is sent from the information providing apparatus 11 to the information presentation terminal 12. The control section 20 of the information presentation terminal 12 thus receives the registration screen image link information and acquires registration screen image data from the information providing apparatus 11 based on the registration screen image link information. Then, the control section 20 controls the display section 26 to display the registration screen image RS based on the registration screen image data.

On the other hand, if the control section 20 of the information presentation terminal 12 receives a request for accessing to the information providing apparatus 11 by an operation of the designation section 21 by the unregistered user, then the control section 20 accesses the information providing apparatus 11 through the network NT.

Then, if one or a plurality of service introduction screen image data are sent from the information providing apparatus 11 through the network NT, then the control section 20 of the information presentation terminal 12 receives the service introduction screen image data through the receiver section 25 and sends the received service introduction screen image data to the display section 26. Consequently, the display section 26 displays one or a plurality of service introduction screen images based on the service introduction screen image data.

In this manner, the information presentation terminal 12 introduces various services to be provided by the information providing apparatus 11 to the unregistered user through the one or plurality of service introduction screen image data displayed on the display section 26.

Referring back to FIG. 2, in addition to the configuration described hereinabove, the information providing apparatus 11 includes a providing information storage section 28. In the providing information storage section 28, such a plurality of pieces of providing information RE as seen in FIG. 4 are stored. The providing information RE is provided to any user irrespective of whether or not the user is a regular user, that is, provided to the information presentation terminal 12 of a regular user and also to the information presentation terminal 12 of an unregistered user.

The providing information RE includes presentation use information BU1 to BUN in the form of a list. The presentation use information BU1 to BUN is used when a plurality of pieces of presentation information to be presented to a user such as information relating to music or artists, news and information which relates to a situation of utilization or management of services are to be presented to a user.

Each of the presentation use information BU1 to BUN includes a title BT applied to corresponding presentation information (the title BT is hereinafter referred to also as presentation information title BT), identification information BD of the presentation information (the information BD is hereinafter referred to as presentation identification information BD), information BK indicative of the type of the presentation information (the information BK is hereinafter referred to also as presentation identification information BK), information BW of a character string which forms the presentation information (such character string is hereinafter referred to also as presentation character string) (the information BW is hereinafter referred to also as presentation character string information BW), and link information BP indicative of an acquisition destination of image data which form the presentation information (such image data is hereinafter referred to also as presentation image data) (the link information BP is hereinafter referred to as presentation image link information BP).

Further, each of the presentation use information BU1 to BUN includes, where the corresponding presentation information relates to music or the like, information EM of the title, artist name, genre and so forth of the music (such information EM is hereinafter referred to also as music information EM).

It is to be noted that, since presentation information is distinguished depending upon a service relating to the substance thereof, the presentation identification information BK indicates a type corresponding to the relating service. Further, presentation mage data include data of a jacket image, image data of a mark of a service relating to the presentation information, and so forth and are stored, for example, in the providing information storage section 28.

Incidentally, the presentation information actually provided includes information for introducing music in response to the season, time or an event, information for introducing music recommended by the information providing side (for example, the management undertaker of the information providing system 10), news for the notification of release of a new single or album by a particular artist, news for the notification of a service to be started newly, news for the notification of music data for distribution prepared newly in the information providing apparatus 11, information for introducing music data distributed frequently within a predetermined period of time such as a week or a month and information for the notification of a shutdown period of services because of maintenance of the information providing apparatus 11.

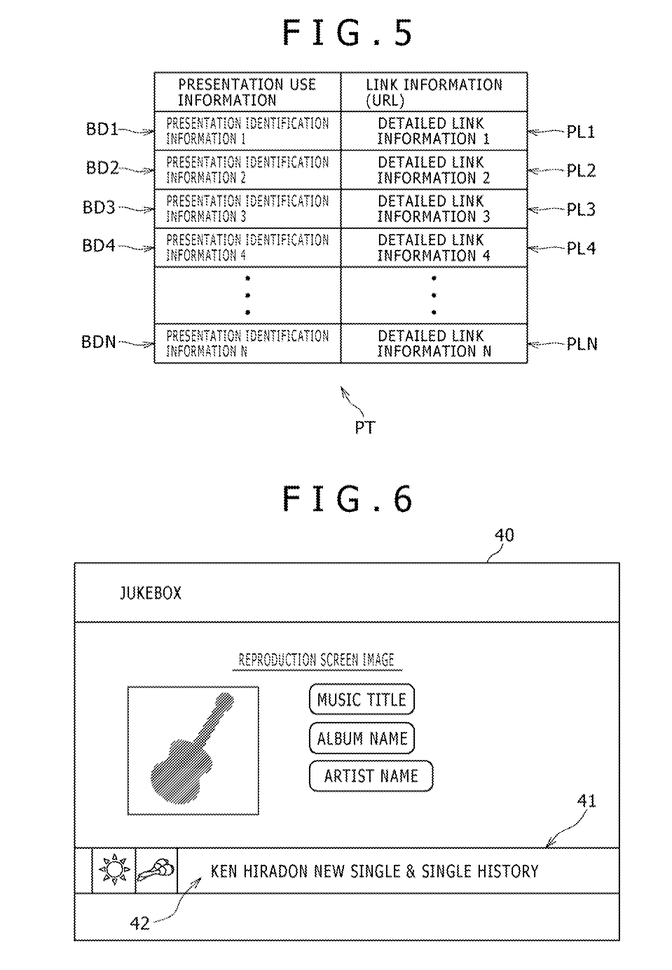

Further, a table PT for the search for detailed information (such table PT is hereinafter referred to as detailed information search table PT) is stored in the providing information storage section 28 as seen in FIG. 5. The detailed information search table PT indicates matching between presentation identification information BD1 to BDN for presentation information and link information PL1 to PLN indicative of acquisition destinations of detailed information for presenting the detailed substance of the presentation information to a user (such link information PL1 to PLN is hereinafter referred to also as detailed link information PL1 to PLN) It is to be noted that such detailed information as mentioned above is stored in a detailed information storage section 29 provided in the information providing apparatus 11 shown in FIG. 2.

Then, if an acquisition request for the providing information RE is sent from the information presentation terminal 12 through the network NT, then the control section 13 of the information providing apparatus 11 receives the acquisition request through the display section 26. Then, the control section 13 reads out the providing information RE from the providing information storage section 28 in accordance with the acquisition request and sends the providing information RE from the sender section 16 to the information presentation terminal 12 through the network NT.

The information presentation terminal 12 receives and stores the providing information RE into a providing information storage section 30 and controls the display section 26 to display the presentation information based on the presentation use information BU1 to BUN included in the providing information RE. Consequently, the presentation information can be presented to both of a regular user and an unregistered user.

Further, if desired presentation information is designated by an operation of the designation section 21 by the user while the presentation information is displayed on the display section 26 based on the providing information RE, then the control section 20 of the information presentation terminal 12 adds the presentation identification information BD of the designated presentation information to an acquisition request for detailed information corresponding to the designated presentation information and sends the resulting acquisition request to the information providing apparatus 11 through the network NT. It is to be noted that, where authentication identification information is temporarily stored in the authentication information storage section 27, the control section 20 adds also the authentication identification information to the acquisition request.

If the acquisition request for detailed information is sent from the information presentation terminal 12 to the information providing apparatus 11 through the network NT, then the control section 13 of the information providing apparatus 11 receives the acquisition request through the display section 26. Then, the authentication processing section 18 performs a series of authentication processes for the information presentation terminal 12 based on the acquisition request similarly as in the case described hereinabove.

If the information presentation terminal 12 is authenticated as being owned by a regular user by the authentication processing section 18, then the control section 13 of the information presentation terminal 12 searches the detailed information search table PT stored in the providing information storage section 28 for detailed link information corresponding to the presentation identification information BD based on the presentation identification information BD added to the acquisition request. Then, the control section 13 sends the detailed link information thus searched out from the sender section 16 to the information presentation terminal 12 through the network NT.

If the detailed link information is sent from the information providing apparatus 11 through the network NT as a result of the authentication performed in response to the acquisition request for detailed information sent thereto, then the control section 20 of the information presentation terminal 12 receives the detailed link information through the receiver section 25. Then, the control section 20 sends an acquisition request for screen image data of the detailed information based on the detailed link information from the sender section 24 to the information providing apparatus 11 through the network NT.

When the acquisition request for screen image data of the detailed information is sent from the information presentation terminal 12 through the network NT, the control section 13 of the information providing apparatus 11 receives the acquisition request through the display section 26. Then, the control section 13 reads out screen image data of corresponding detailed information from the detailed information storage section 29 in accordance with the acquisition request and sends the screen image data from the sender section 16 to the information presentation terminal 12 through the network NT. As a result, a detailed information screen image based on the screen image data of the detailed information is displayed on the display section 26 of the information presentation terminal 12.

On the other hand, if the information presentation terminal 12 is not authenticated as being owned by a regular user by the authentication processing section 18, then the control section 13 of the information providing apparatus 11 decides that an acquisition request for the detailed information is sent thereto from the information presentation terminal 12 of an unregistered user. Then, the control section 13 reads out registration screen image link information from the registration information storage section 15 and sends the registration screen image link information from the sender section 16 to the information presentation terminal 12 through the network NT.

In this manner, when a utilization request for detailed information is sent from the information presentation terminal 12 of an unregistered user, the information providing apparatus 11 causes the information presentation terminal 12 to display the registration screen image RS thereby to urge the unregistered user to perform user registration.

Incidentally, while the control section 20 of the information presentation terminal 12 executes various functions such as the recorded data reproduction function and the media reproduction function, it controls the display section 26 to display a function execution screen image for allowing a user to visually observe information according to an execution situation of the function (such information is hereinafter referred to as function execution information).

Thus, when the function execution screen image is displayed on the display section 26, the control section 20 of the information presentation terminal 12 causes presentation information to be displayed together with function execution information on the function execution screen image. As a result, the information presentation terminal 12 can present presentation information to a user together with the function execution function even when any of various function is being executed.

As an actual information presentation method for presenting presentation information through the function execution screen image, three information presentation methods including first to third information presentation methods are available. In particular, the control section 20 of the information presentation terminal 12 allows the user to arbitrarily set an information presentation method to be used for the presentation of presentation information. In the following, the first to third information presentation methods are described successively together with the configuration of various function execution screen images.

First, a case is described wherein the user sets that the first information presentation method is used for the presentation of presentation information. It is to be noted here that the description is given taking a case wherein presentation information is presented through a function execution screen image displayed on the display section 26 (such function execution screen image is hereinafter referred to also as storage data reproduction function execution screen image) during execution of the storage data reproduction function as an example.

After the control section 20 of the information presentation terminal 12 executes the storage data reproduction function in response to a user operation, it reads out data of a storage data reproduction function execution screen image stored in advance in the data storage section 23. Further, the control section 20 reads out data attribute information of music data to be reproduced from the data storage section 23 and extract the music title, artist name, album name and image link information of jacket image data from the data attribute information. Furthermore, the control section 20 acquires the jacket image data from an acquisition destination of the same (for example, from the information providing apparatus 11) based on the image link information.

Then, the control section 20 synthesizes the information of the music title, artist name and album name and a jacket image based on the jacket image data as function execution information with the data of the storage data reproduction function execution screen image to produce storage data reproduction function execution screen image data.

Further, the control section 20 reads out the providing information RE from the providing information storage section 30 and extracts the presentation use information BU1 to BUN from the providing information RE. Furthermore, the control section 20 extracts the presentation character string information BW and the presentation image link information BP from the presentation use information BU1 to BUN and acquires presentation image data from its acquisition destination (for example, from the information providing apparatus 11) based on the presentation image link information BP.

Then, the control section 20 synthesizes the presentation information based on the presentation character string information BW and the presentation image data of the presentation use information BU1 to BUN as presentation information with the storage data reproduction function execution screen image data. Then, the control section 20 sends the storage data reproduction function execution screen image data to the display section 26.

As a result, a storage data reproduction function execution screen image 40 based on the storage data reproduction function execution screen image data is displayed on the display section 26 as seen in FIG. 6.

At a central portion of the storage data reproduction function execution screen image 40, the music title, album name, artist name and jacket image corresponding to the music data being reproduced are displayed as function execution information of the storage data reproduction function. Further, a belt-shaped presentation information display region 41 is provided at a lower portion of the storage data reproduction function execution screen image 40 such that it extends in the leftward and rightward direction of the screen, and presentation information 42 in the form of, for example, a presentation image and a presentation character string is displayed in the presentation information display region 41.

Here, where the presentation information 42 can be entirely displayed in the presentation information display region 41, the control section 20 of the information presentation terminal 12 continues to display the presentation information 42 for a predetermined period of time (for example, approximately several seconds). On the other hand, if the presentation information 42 may not be entirely displayed in the presentation information display region 41, then the control section 20 scrolls the presentation information 42 horizontally within the presentation information display region 41 so that the presentation information 42 is displayed entirely.

Further, after the presentation information 42 is displayed for the predetermined period of time in the presentation information display region 41, the control section 20 changes over the presentation information 42 to be displayed in the presentation information display region 41 to next presentation information 42.

In this manner, while the storage data reproduction function execution screen image 40 is displayed on the display section 26, the information presentation terminal 12 continues to display the presentation information 42 within the presentation information display region 41 and changes over the presentation information 42 so that it is displayed after every predetermined interval of time.

Now, a case is described wherein the user sets that the second information presentation method is used for the presentation of presentation information. It is to be noted here that the description is given taking a case wherein presentation information is presented through a function execution screen image displayed on the display section 26 (such function execution screen image is hereinafter referred to also as media reproduction function execution screen image) during execution of the media reproduction function as an example.

When the control section 20 of the information presentation terminal 12 executes a media reproduction function in response to a user operation, it reads out data of a media reproduction function execution screen image stored in advance in the data storage section 23. Further, the control section 20 acquires data attribute information of music data to be reproduced from a media from an external attribute providing apparatus (not shown) and extracts music titles, artist names, album names and image link information from the data attribute information. Further, the control section 20 acquires jacket image data from its acquisition destination (for example, the information providing apparatus 11) based on the image link information.

Then, the control section 20 synthesizes the information of the music title, artist name and album name and a jacket image based on the jacket image data as function execution information with data of the media reproduction function execution screen image to produce media reproduction function execution screen image data.

Further, the control section 20 reads out the providing information RE from the providing information storage section 30 and extracts the presentation use information BU1 to BUN from the providing information RE. Furthermore, the control section 20 extracts the presentation character information BW and the presentation image link information BP from each of the pieces BU1 to BUN of presentation use information and acquires presentation image data from their acquisition destination (for example, the information providing apparatus 11) based on the presentation image link information BP.

Then, the control section 20 synthesizes presentation images based on the presentation character information BW and the presentation image data of the presentation use information BU1 to BUN as presentation information with the media reproduction function execution screen image data. Then, the control section 20 sends the media reproduction function execution screen image data to the display section 26.

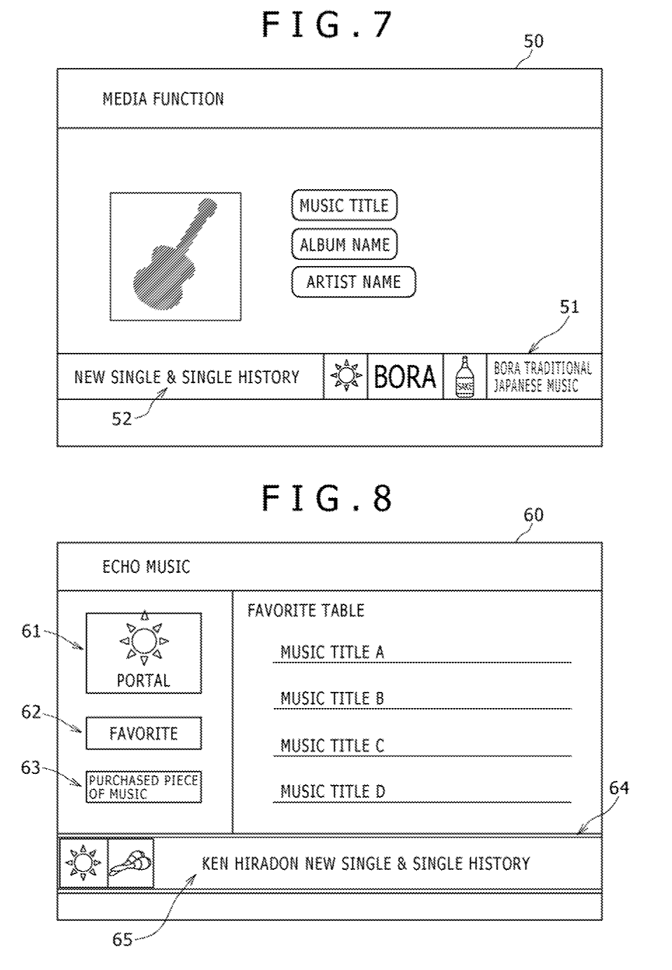

As a result, a media reproduction function execution screen image 50 based on the media reproduction function execution screen image data is displayed on the display section 26 as seen in FIG. 7.

The media reproduction function execution screen image 50 has a basic configuration similar to that of the storage data reproduction function execution screen image 40 described hereinabove. In particular, at a central portion of the media reproduction function execution screen image 50, the music title, album name, artist name and jacket image corresponding to the music data being reproduced are displayed as the function execution information of the media reproduction function. Further, a belt-shaped presentation information display region 51 is provided at a lower portion of the media reproduction function execution screen image 50 such that it extends in the leftward and rightward direction of the screen, and a plurality of pieces 52 of presentation information each in the form of, for example, a presentation image and a presentation character string are displayed in a horizontally aligned relationship in the presentation information display region 51.

Then, the control section 20 of the information presentation terminal 12 causes the presentation information 52 joined together to scroll from the right to the left within the presentation information display region 51.

In this manner, while the media reproduction function execution screen image 50 is displayed on the display section 26, the information presentation terminal 12 causes the presentation information 52 to scroll in order within the presentation information display region 51 to display the presentation information 52.

Now, a case is described wherein the user sets that the third information presentation method is used for the presentation of presentation information. It is to be noted here that the description is given taking a case wherein presentation information is presented through a function execution screen image displayed on the display section 26 (such function execution screen image is hereinafter referred to also as music purchase function execution screen image) during execution of the music purchase function as an example.

The control section 20 of the information presentation terminal 12 executes the music purchase function in response to a user operation to read out data of the music purchase function execution screen image stored in advance in the data storage section 23. Incidentally, also a list of music selected as a favorite by the user (such list is hereinafter referred to also as favorite list) is stored in the data storage section 23, and the control section 20 reads out also the favorite list upon such reading out as described above. Then, the control section 20 synthesizes the favorite list as function execution information with the data of the music purchase function execution screen image to produce music purchase function execution screen image data.

Further, the control section 20 reads out the providing information RE from the providing information storage section 30 and extracts the presentation use information BU1 to BUN from the providing information RE. Furthermore, the control section 20 extracts the presentation character string information BW and the presentation image link information BP from each of the pieces BU1 to BUN of presentation use information and acquires presentation image data from their acquisition destination (for example, the information providing apparatus 11) based on the presentation image link information BP.

Then, the control section 20 synthesizes a presentation image based on the presentation character string information BW and the presentation image data of each of the pieces BU1 to BUN of presentation use information as presentation information with the music purchase function execution screen image data. Then, the control section 20 sends the synthesized music purchase function execution screen image data to the display section 26.

As a result, a music purchase function execution screen image 60 based on the music purchase function execution screen image data is displaced on the display section 26 as seen in FIG. 8.

At a left side portion of the music purchase function execution screen image 60, a service notification mark 61 representative of a music data distribution service, a favorite list selection button 62 for selecting the favorite list and a purchase list selection button 63 for selecting a purchase list are displayed. Further, at a right side portion of the music purchase function execution screen image 60, for example, music titles corresponding to one or a plurality of music data registered in the favorite list are displayed in a list. Furthermore, at a lower portion of the music purchase function execution screen image 60, a belt-shaped presentation information display region 64 is provided such that it extends in the leftward and rightward direction of the screen, and presentation information 65 in the form of, for example, a presentation image and a presentation character string is displayed in the presentation information display region 64.

Then, if the service notification mark 61 of the music purchase function execution screen image 60 is selected by a user operation, then the control section 20 acquires the music introduction screen image data described hereinabove from the information providing apparatus 11 and controls the display section 26 to display a music introduction screen image (not shown) in place of the music purchase function execution screen image 60 being displayed.

On the other hand, if the purchase list selection button 63 is selected by a user operation, then the control section 20 controls the display section 26 to display music titles corresponding to one or a plurality of music data registered in the purchase list in the form of a list in place of the favorite list at the right portion of the music purchase function execution screen image 60. Further, if the favorite list selection button 62 is selected by a user operation, then the control section 20 controls the display section 26 to display the music titles corresponding to the one or plural music data registered in the favorite list in the form of a list in place of the purchase list.

In this manner, by causing the music purchase function execution screen image 60 to display the music titles of the music data registered in the favorite list or the music titles of the music data registered in the purchase list on the music purchase function execution screen image 60, the information presentation terminal 12 allows the user to refer to the displayed information to determine music data to be purchased.

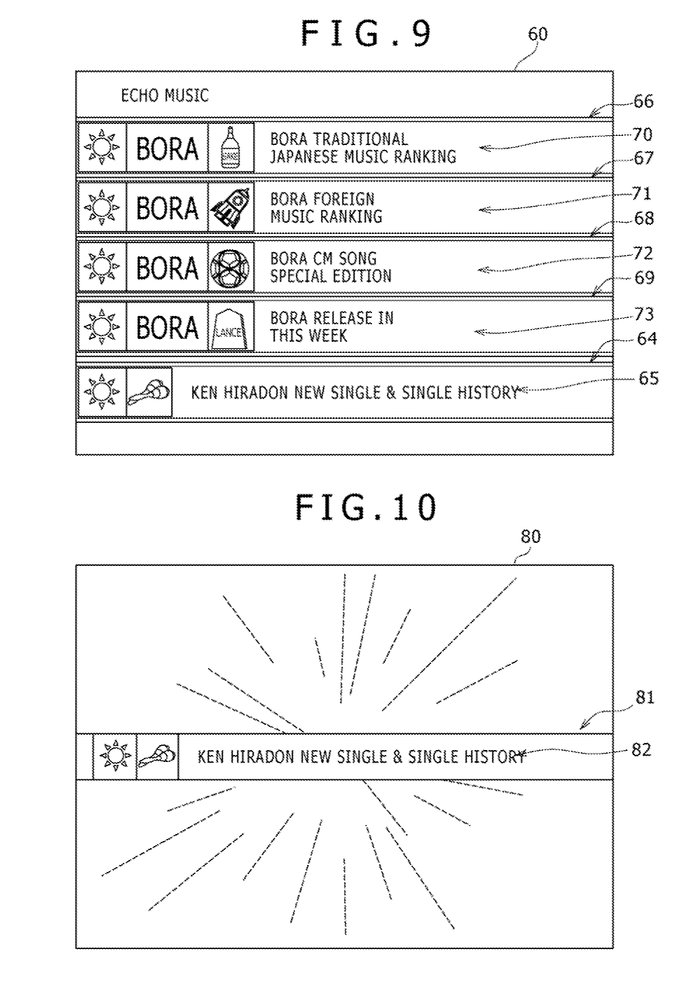

Incidentally, if a list display instruction which designates list display of a plurality of pieces of presentation information is inputted through the designation section 21 by the user while, for example, the music purchase function execution screen image 60 is displayed on the display section 26, then the control section 20 updates the display substance of the music purchase function execution screen image 60 in response to the list display instruction. Consequently, the music purchase function execution screen image 60 on which the presentation information is displayed in a list is displayed on the display section 26 as seen in FIG. 9.

On the music purchase function execution screen image 60 in this instance, a plurality of presentation information display regions 64, 66 and 69 are disposed in a vertically juxtaposed relationship with each other, and presentation information 65, 70 and 73 is displayed in the presentation information display regions 64, 66 and 69, respectively.

At this time, if the entirety of the presentation information 65, 70 and 73 may not be displayed within the presentation information display regions 64, 66 and 69, then the control section 20 of the information presentation terminal 12 causes the presentation information 65, 70 and 73 to be horizontally scrolled within the presentation information display regions 64, 66 and 69, respectively, so that the entire of the presentation information 65, 70 and 73 can be displayed.

However, when all presentation information of the providing information RE can be displayed in the presentation information display regions 64, 66 and 69 of the music purchase function execution screen image 60, the control section 20 causes the presentation information 65, 70 and 73 to be displayed in the presentation information display regions 64, 66 and 69, respectively. On the other hand, when all presentation information of the providing information RE may not be displayed in the presentation information display regions 64, 66 and 69, then after the presentation information 65, 70 and 73 is displayed for a predetermined period of time in the presentation information display regions 64, 66 and 69, respectively, the presentation information 65, 70 and 73 to be displayed in the presentation information display regions 64, 66 and 69 is changed over to next presentation information 65, 70 and 73, respectively, such that all presentation information of the providing information RE is displayed in different time periods.

In this manner, the information presentation terminal 12 can present a plurality of pieces 65, 70 and 73 of presentation information at a time through the music purchase function execution screen image 60.

Further, if a predetermined interval of time (for example, 5 minutes) elapses while no instruction is inputted by the user in a power-on state, then the control section 20 of the information presentation terminal 12 changes over the display of the display section 26 to a standby screen image 80 called screen saver as seen in FIG. 10.

Then, the control section 20 controls the display section 26 to display the standby screen image 80 in such a state that a plurality of pieces 82 of presentation information each in the form of, for example, a presentation image and a presentation character string are joined in a horizontal row in a belt-shaped presentation information display region 81 which is provided at a central portion of the standby screen image 80 and extending in the leftward and rightward direction of the screen. Further, the control section 20 causes the presentation information 82 joined together to be scrolled horizontally within the presentation information display region 81.

In this manner, also while the standby screen image 80 is displayed, the information presentation terminal 12 can present presentation information to the user.

Incidentally, if one of the pieces of presentation information being displayed is designated by an operation of the designation section 21 by the user while the presentation information is displayed on the display section 26 in such a manner as described above, then the control section 20 of the information presentation terminal 12 extracts presentation identification information BD of the presentation information from that one of the pieces BU1 to BUN of presentation use information corresponding to the designated presentation information.

Then, the control section 20 adds the presentation identification information BD to an acquisition request for detailed information corresponding to the designated presentation information and sends the resulting acquisition request to the information providing apparatus 11 through the network NT. It is to be noted that, where authentication identification information is temporarily stored in the authentication information storage section 27, the control section 20 adds also the authentication identification information to the acquisition request.

If detailed link information is sent from the information providing apparatus 11 through the network NT after the information presentation terminal 12 is authenticated by the information providing apparatus 11 in response to the sending of the acquisition request for detailed information, then the control section 20 of the information presentation terminal 12 receives the detailed link information through the receiver section 25. Then, the control section 20 sends an acquisition request for screen image data of the detailed information to the information providing apparatus 11 through the network NT based on the detailed link information.

If screen image data of detailed information corresponding to the presentation information designated by the user is sent from the information providing apparatus 11 through the network NT in response to the sending of the acquisition request for screen image data, then the control section 20 of the information presentation terminal 12 receives the screen image data through the receiver section 25 and sends the screen image data to the display section 26. Consequently, the display section 26 displays a detailed information screen image based on the screen image data.

In this manner, the information presentation terminal 12 can present detailed information corresponding to presentation information designated by the user to the user.

On the other hand, if registration screen image link information is sent from the information providing apparatus 11 through the network NT because the information presentation terminal 12 is not authenticated by the information providing apparatus 11, then the control section 20 of the information presentation terminal 12 receives the registration screen image link information through the receiver section 25. Then, the control section 20 acquires registration screen image data from the information providing apparatus 11 based on the registration screen link information and controls the display section 26 to display a registration screen RS based on the registration screen image data.

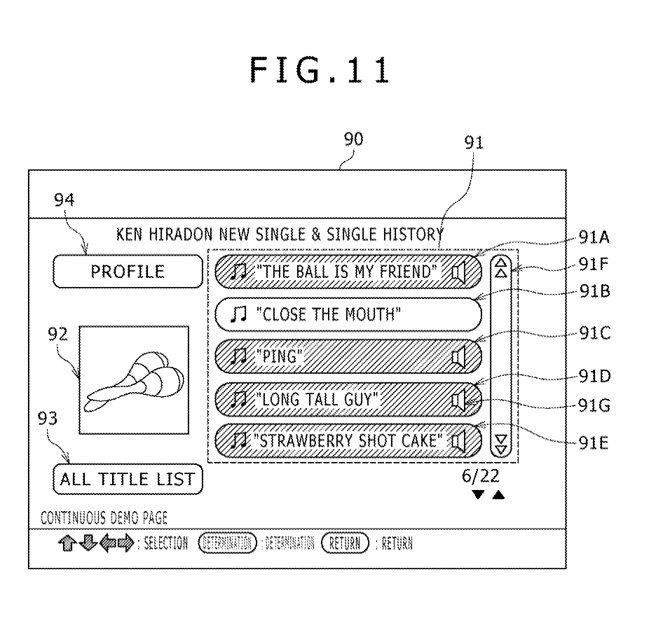

Here, if the screen image data of the detailed information is acquired, then the control section 20 of the information presentation terminal 12 controls the display section 26 to display such a detailed information screen image 90 as shown in FIG. 11 based on the screen image data. Here, the detailed information screen image 90 is a display example where detailed information corresponding to presentation information which is news of notification of release of a new single by a particular artist is displayed.

At a central portion of the detailed information screen image 90, a title display portion 91 is provided which includes a plurality of title display places 91A to 91E disposed in a juxtaposed relationship in a vertical direction of the screen. In each of the title display places 91A to 91E of the title display portion 91, a music title of a single released by the particular artist is displayed.

Also a scrolling operation portion 91F for scrolling the title display places 91A to 91E in the vertical direction is provided on the title display portion 91. Further, where music data for a demo (such data is hereinafter referred to as demo data) is matched with a music title to be displayed, a mark 91G which schematically shows, for example, the shape of a speaker is displayed in each of the title display places 91A to 91E.

Further, the detailed information screen image 90 has an image display portion 92, an all title list display button 93 and a profile display button 94 provided at a left portion thereof. The image display portion 92 allows a jacket image, which corresponds to the music title in any of the title display places 91A to 91E, to be displayed therein. The all title list display button 93 allows a list of all music titles released till now by a particular artist to be displayed therein. Further, the profile display button 94 allows a profile of the predetermined artist to be displayed therein.

Then, if a music title displayed together with a mark 91G from among the music titles displayed in the title display places 91A to 91E is selected by a user operation while the detailed information screen image 90 is displayed, then the control section 20 of the information presentation terminal 12 reads out link information indicative of an acquisition destination of demo data. Then, the control section 20 acquires the demo data from the information providing apparatus 11 based on the link information and sends the demo data to the reproduction section 22. Consequently, the information presentation terminal 12 allows the user to listen to music corresponding to the selected music title.

If one of the music titles displayed in the title display places 91A to 91E is selected, then the control section 20 extracts link information indicative of an acquisition destination of jacket image data from detailed information. Then, the control section 20 acquires jacket image data from the information providing apparatus 11 based on the link information and controls the display section 26 to display a jacket image to be displayed in the image display portion 92 of the detailed information screen image 90 based on the jacket image data.

Further, if the all title list display button 93 is selected, then the control section 20 extracts link information indicative of the acquisition destination of the all title list from the detailed information. Then, the control section 20 acquires the all title list from the information providing apparatus 11 based on the link information and causes the music titles included in the all title list to be displayed, for example, in the title display portion 91 of the detailed information screen image 90.

Further, if the profile display button 94 is selected, then the control section 20 extracts link information indicative of an acquisition destination of data of a profile (such data is hereinafter referred to as profile data) from the detailed information. Then, the control section 20 acquires the profile data from the information providing apparatus 11 based on the link information and controls the display section 26 to display a profile based on the profile data, for example, in the image display portion 92 of the detailed information screen image 90.

In this manner, the information presentation terminal 12 presents various kinds of information relating to the substance of presentation information designated by a user as detailed information corresponding to the presentation information to the user.

### 1-3. History Information Management Function

In addition to such basic functions as described above, the information providing apparatus 11 of the information providing system 10 has a history information management function for managing the date and hour at which any request is sent from an information presentation terminal 12 connected thereto through the network NT, the type of the request received and so forth as history information indicative of the operation history of the terminal. In the following, the history information management function is described.

In management of the history information for each information presentation terminal 12, the information providing apparatus 11 applies, to each of information presentation terminals 12 connected thereto through the network NT, terminal identification information unique to the information presentation terminal 12.

In particular, if an acquisition request for terminal identification information is sent, for example, from an information presentation terminal 12 purchased by a user and connected for the first time to the network NT, then the control section 13 of the information providing apparatus 11 receives the acquisition request through the receiver section 14. Then, the control section 13 sends the received acquisition request to the terminal registration section 100 (FIG. 2) of the information providing apparatus 11.

The terminal registration section 100 produces terminal identification information unique to the information presentation terminal 12 from which the acquisition request is sent in response to the acquisition request and returns the terminal identification information to the control section 13. The control section 13 sends the terminal identification information from the sender section 16 to the information presentation terminal 12 from which the acquisition request is sent through the network NT.

When the terminal identification information is sent from the information providing apparatus 11 through the network NT, the control section 20 receives the terminal identification information through the receiver section 25 and stores the terminal identification information, for example, into a predetermined region of the data storage section 23. Then, the control section 20 issues a notification that the terminal identification information is stored to the information providing apparatus 11 together with the terminal identification information through the network NT.

Then, when the information presentation terminal 12 thereafter sends various requests to the information providing apparatus 11, the control section 20 thereof adds the terminal identification information thereof read out from the predetermined region of the data storage section 23 to the request every time and sends the request.

Consequently, the information providing apparatus 11 can recognize from which information presentation terminal 12 each request is received through the network NT and manage history information for each information presentation terminal 12.

Actually, for example, when an acquisition request for terminal identification information is issued from an information presentation terminal 12 as described hereinabove, when a notification that terminal identification information is stored (this notification is regarded as a request) is issued, when an acquisition request for providing information RE is issued, when an acquisition information for detailed information is issued or in a like case, the control section 20 of the information providing apparatus 11 controls the history information management section 101 to produce history information representing this. Then, the control section 20 stores the produced history information into the history information storage section 102.

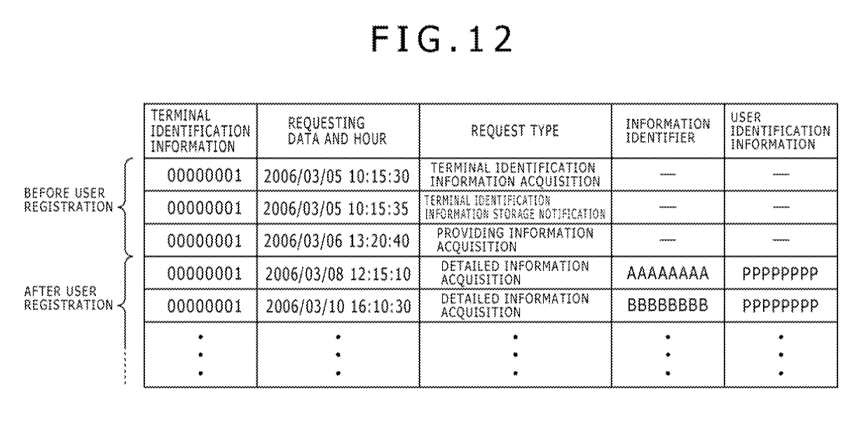

Referring to FIG. 12, the history information includes the terminal identification information of an information presentation terminal 12 from which a request is issued, the date and hour of the issuance of the request, the type of the request issued, an identifier of information (here, this indicates the presentation identification information BD of presentation information) to be acquired by the information presentation terminal 12 of a regular user through the request and the user identification information of the user of the information presentation terminal 12 from which the request is issued.

In particular, for example, if an acquisition request for terminal identification information is issued from the information presentation terminal 12, then the history information management section 101 produces history information which describes terminal identification information (for example, “00000001”) applied to the information presentation terminal 12 at this time, the date and hour (for example, 2006/03/05 10:15:30) at this time and the request type (terminal identification information acquisition) in this instance. Then, the history information management section 101 stores the produced history information into the history information storage section 102. It is to be noted that, in this instance, since the user of the information presentation terminal 12 does not perform user registration as yet, nothing is described into the information identifier of the history information and the user identification information.

Thereafter, when a notification that the terminal identification information is stored is received from the information presentation terminal 12, then the history information management section 101 produces history information which describes the terminal identification information included in the notification (that is, the terminal identification information applied to the information presentation terminal 12 from which the notification is received, and, for example, “00000001”), the date and hour of the time (for example, 2006/03/05 10:15:35”) and the request type in this instance (for example, “terminal identification information storage notification”). Then, the history information management section 101 stores the produced history information into the history information storage section 102. Also in this instance, since the user of the information presentation terminal 12 does not perform user registration as yet, nothing is described into the information identifier of the history information and the user identification information.

Thereafter, for example, if an acquisition request for providing information RE is issued from the information presentation terminal 12, then the history information management section 101 produces history information in which the terminal identification information added to the acquisition request (that is, the terminal identification information added to the information presentation terminal 12 from which the acquisition request is sent, and, for example, “00000001”), the date and hour at this time (for example, 2006/03/06 13:20:40) and the request type “providing information acquisition” in this instance are described. Then, the history information management section 101 stores the produced history information into the history information storage section 102. Also in this instance, since the user of the information presentation terminal 12 does not perform user registration as yet, nothing is described into the information identifier of the history information and the user identification information.

In this manner, if the information providing apparatus 11 receives a request from the information presentation terminal 12, then it cumulatively stores an effect of this as history information matched with the terminal identification information into the history information storage section 102. Consequently, also before the user registration, the operation history of each information presentation terminal 12 can be managed based on the terminal identification information.

Further, for example, if an acquisition request for detailed information is thereafter issued from the information presentation terminal 12, then since the user of the information presentation terminal 12 is an unregistered user, the control section 13 of the information providing apparatus 11 urges the user to perform user registration through the registration screen RS as described hereinabove. In other words, the acquisition request for detailed information for the first time from an unregistered user can be regarded also as user registration request.

Then, if user identification information, a password and a nickname are inputted through the registration screen RS by the unregistered user and sent as user registration information from the information presentation terminal 12 through the network NT, then the control section 13 of the information providing apparatus 11 receives them through the receiver section 14 and sends them to the user registration section 17. Also the terminal identification information added to the acquisition request for detailed information received formerly is sent from the control section 13 to the user registration section 17.

As the user registration section 17 stores the user registration information into the registration information storage section 15, the user of the information presentation terminal 12 is registered as a regular user, and as the user registration information and the terminal identification information are stored in a matched relationship with each other into the history information storage section 102, the user identification information of the user and the terminal identification information of the information presentation terminal 12 of the user are linked with each other.

In this manner, when user registration is performed, the user identification information and the terminal identification information of the information presentation terminal 12 of the user whose user registration is performed are linked with each other, it can be specified to which history information before the user registration (that is, history information which does not have the user registration information) stored in the history information storage section 102 the history information before the user registration whose user registration is performed corresponds.

Further, at this time, the history information management section 101 produces history information wherein the identifier of the information acquired by the information presentation terminal 12 in accordance with the acquisition request for detailed information (that is, the presentation identification information BD added to the acquisition request for detailed information and, for example, “AAAAAAAA”) and the user identification information (for example, “PPPPPPPP”) linked with the terminal identification information are described in addition to the terminal identification information added to the acquisition request for detailed information received formerly (that is, the terminal identification information applied to the information presentation terminal 12 from which the acquisition request is received and, for example, “00000001”), the date and hour of the event (for example, 2006/03/08 12:15:10) and the user type “detailed information acquisition” in this instance. Then, the history information management section 101 stores the produced history information into the history information storage section 102.

Thereafter, if an acquisition request for detailed information is issued from the information presentation terminal 12 again, then the history information management section 101 produces history information wherein the terminal identification information added to the received acquisition request for detailed information (that is, the terminal identification information applied to the information presentation terminal 12 from which the acquisition request is received and, for example, “00000001”), the date and hour of the event (for example, 2006/03/10 16:10:30), the user type “detailed information acquisition” in this instance, the identifier of the information acquired by the information presentation terminal 12 in accordance with the acquisition request for detailed information (that is, the presentation identification information BD added to the acquisition request for detailed information and, for example, “BBBBBBBB”) and the user identification information (for example, “PPPPPPPP”) linked with the terminal identification information are described. Then, the history information management section 101 stores the produced history information into the history information storage section 102.

In this manner, if any request is received from an information presentation terminal 12 of a user (regular user) after its user registration, then the information providing apparatus 11 cumulatively stores the effect as history information matched with terminal identification information of the information presentation terminal 12 and user identification information of the user into the history information storage section 102. Consequently, also after the user registration, the information providing apparatus 11 can continuously manage the operation history of each information presentation terminal 12 based on the terminal identification information.

As a result, the information providing apparatus 11 can manage history information before user registration and history information after user registration in a concentrated fashion based on terminal identification information. Further, by referring to the history information managed in a concentrated fashion in this manner, the information providing apparatus 11 can recognize any request issued from each information presentation terminal 12 together with time of such issuance before user registration and any request for information issued from each information presentation terminal 12 together with time of such issuance after user registration.

More particularly, if the control section 13 of the information providing apparatus 11 refers to, for example, the date of request for history information whose request type is “terminal identification information acquisition” from within the history information stored in the history information storage section 102 and having the terminal identification information of “00000001”, then it can recognize the date and hour at which the information presentation terminal 12 whose terminal identification information is “00000001”was connected for the first time to the network NT.

Further, for example, if the control section 13 refers to the oldest date and hour of the request for the history information whose terminal identification information is “00000001”and in which user identification information is described, then it can recognize the data and hour at which user registration of the user of the information presentation terminal 12 whose terminal identification information is “00000001”was performed. Further, if the control section 13 refers to the information identifier of the history information, then it can recognize what information the user intended to acquire by the user registration.

Furthermore, for example, if the control section 13 refers to the information identifier of the history information in which user identification information is described from within the history information whose terminal identification information is “00000001”, then it can recognize in what presentation information the user of the information presentation terminal 12 whose terminal identification information is “00000001”is interested after the user registration.

Further, the control section 13 plays a roll as an information selection section (FIG. 2) for selecting presentation information to be presented to a regular user based on such history information.

More particularly, if an acquisition request for the providing information RE is issued from the information presentation terminal 12 of a regular user, then the control section 13 recognizes, based on the history information of the information presentation terminal 12 stored in the history information storage section 102, for example, in what presentation information the user of the information presentation terminal 12 is interested after its user registration.

Then, if the control section 13 recognizes that the user is interested, for example, in presentation information relating to a particular artist, then it selects the presentation use information BU1 to BUN corresponding to the presentation information relating to the particular artist as the presentation use information BU1 to BUN to be included in the providing information RE and produces providing information RE in which the presentation use information BU1 to BUN corresponding to the presentation information relating to the particular artist is included. Then, the control section 13 sends the produced providing information RE to the information presentation terminal 12.

Consequently, presentation information relating to the particular artist in which the user is interested is displayed on the display section 26 of the information presentation terminal 12.

Further, the control section 13 recognizes, for example, the data and hour of the first connection of the information presentation terminal 12 to the network NT based on the history information of the information presentation terminal 12 from which an acquisition request for the providing information RE is issued.

If it is recognized that, for example, more than one year elapse from the date and hour of the first connection of the information presentation terminal 12 to the network NT, then the control section 13 provides, as the presentation use information BU1 to BUN to be included in the providing information RE, presentation use information BU1 to BUN corresponding to presentation information of the substance for recommending purchase replacement to the information presentation terminal 12 to produce providing information RE in which the presentation use information BU1 to BUN corresponding to the presentation information of the substance for recommendation of replacement purchases to the new information presentation terminal 12 is included. Then, the control section 13 sends the produced providing information RE to the information presentation terminal 12.

Consequently, presentation information of the substance for recommending replacement purchase to the information presentation terminal 12 is displayed on the display section 26 of the information presentation terminal 12.

Furthermore, the control section 13 recognizes, for example, the user registration of the user of the information presentation terminal 12 based on the history information of the information presentation terminal 12 from which an acquisition request for providing information RE is issued.

Then, if the date of the user registration of the user of the information presentation terminal 12 is, for example, within one month, then the control section 13 selects, as the presentation use information BU1 to BUN to be included in the providing information RE, the presentation use information BU1 to BUN corresponding to presentation information indicative of a manner of simple use of services which can be utilized by a regular user and produces providing information RE in which the presentation use information BU1 to BUN corresponding to the display information indicative of a simple manner of use of services which can be utilized by a regular user and so forth is included. Then, the control section 13 sends the produced providing information RE to the information presentation terminal 12.

Consequently, presentation information indicative of a simple manner of use of services which can be utilized by a regular user and so forth is displayed on the display section 26 of the information presentation terminal 12.

In this manner, when presentation information to be presented to a regular user is to be selected, the information providing apparatus 11 can effectively utilize not only history information after user registration but also history information after the user registration. Consequently, presentation information suitable for the user can be sent to the information presentation terminal 12 of the user so that it can be provided to the user.

It is to be noted that the control section 13 of the information providing apparatus 11 corresponds to the information selection section 7 of the information processing apparatus 1 described hereinabove with reference to FIG. 1. Further, the receiver section 14 and the sender section 16 correspond to the sender section 3 and the receiver section 4 of the information processing apparatus 1, respectively, and furthermore, the user registration section 17, terminal registration section 100, history information management section 101 and history information storage section 102 correspond to the user registration section 8, terminal registration section 2, history information management section 6 and storage section 5 of the information processing apparatus 1, respectively.

### 1-4. History Information Storage Processing Procedure

Here, a procedure of a process of storing history information described hereinabove (the procedure is hereinafter referred to also as history information storage processing procedure). The history information storage processing procedure is executed principally by the control section 13 of the information providing apparatus 11 in cooperation with the control section 20 of the information presentation terminal 12.

It is to be noted here that the history information storage processing procedure can be divided into two portions including a first history information storage processing procedure after the information presentation terminal 12 is connected to the network NT until the information providing apparatus 11 sends providing information RE to the information presentation terminal 12 and a second history information storage processing procedure after a piece of presentation information displayed on the information presentation terminal 12 based on the providing information RE is designated until the information providing apparatus 11 sends screen image data of detailed information of the designated presentation information to the information presentation terminal 12.

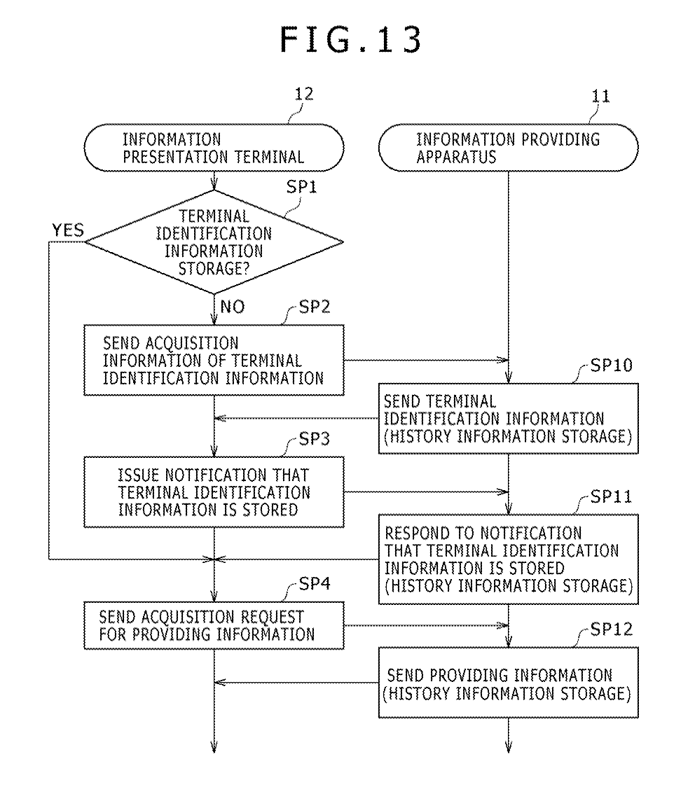

First, the first history information storage processing procedure is described with reference to a sequence chart shown in FIG. 13. If the information presentation terminal 12 is connected to the network NT, then the control section 20 thereof decides at step SP1 whether or not the terminal identification information of the information presentation terminal 12 itself is stored in a predetermined region of the data storage section 23.

If a negative result is obtained at step SP1, then this signifies, for example, that the information presentation terminal 12 is connected for the first time now, and in this instance, the processing of the control section 20 of the information presentation terminal 12 advances to step SP2. At step SP2, the control section 20 of the information presentation terminal 12 sends an acquisition request for terminal identification information from the sender section 24 to the information providing apparatus 11 through the network NT.

When the acquisition request for terminal identification information sent from the information presentation terminal 12 is received by the receiver section 14, the control section 13 of the information providing apparatus 11 controls, at step SP10, the terminal registration section 100 to produce terminal identification information for the information presentation terminal 12 from which the acquisition request is received, and sends the produced terminal identification information from the sender section 16 to the information presentation terminal 12 through the network NT. Further, at step SP10, the control section 13 controls the history information management section 101 to produce history information (in which the terminal identification information is described) representing that the terminal identification information is issued from the information presentation terminal 12, and stores the produced history information into the history information storage section 102.

After the terminal identification information sent from the information providing apparatus 11 is received by the receiver section 25 and stored into a predetermined region of the data storage section 23, the control section 20 of the information presentation terminal 12 issues a notification that the terminal identification information is stored to the information providing apparatus 11 through the network NT at step SP3.

If the notification that terminal identification information is stored is received from the information presentation terminal 12, then at step SP11, the control section 13 of the information providing apparatus 11 sends a response to the notification to the information presentation terminal 12 through the network NT. Further, at step SP11, the control section 13 controls the history information management section 101 to produce history information indicating that the notification that terminal identification information is stored is received from the information presentation terminal 12 (the history information describes the terminal identification information) at step SP11. Then, the control section 13 stores the produced history information into the history information storage section 102.

When a response to the notification that terminal identification information is stored is received from the information providing apparatus 11 through the receiver section 25, or when an affirmative result is obtained at step SP1 described hereinabove, the control section 20 of the information presentation terminal 12 sends an acquisition request for providing information RE from the sender section 24 to the information providing apparatus 11 through the network NT at step SP4.

When the control section 13 of the information providing apparatus 11 receives the acquisition request for providing information RE sent thereto from the information presentation terminal 12 through the receiver section 14, it reads out providing information from the providing information storage section 28 and sends the read out providing information from the sender section 16 to the information presentation terminal 12 through the network NT at step SP12. Further, at step SP12, the control section 13 controls the history information management section 101 to produce history information (in which the terminal identification is described) representing that an acquisition request for providing information RE is issued from the information presentation terminal 12. Then, the control section 13 stores the history information into the history information storage section 102.

When any request is sent from the information presentation terminal 12, the control section 13 of the information providing apparatus 11 stores history information into the history information storage section 102 every time in accordance with such a first history information storage processing procedure as described hereinabove,.

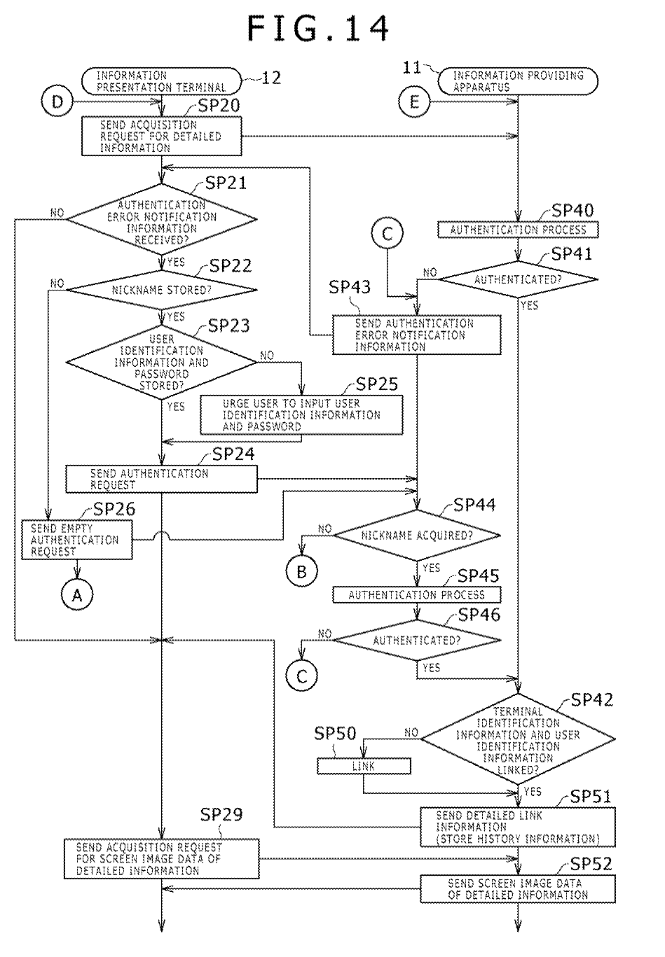

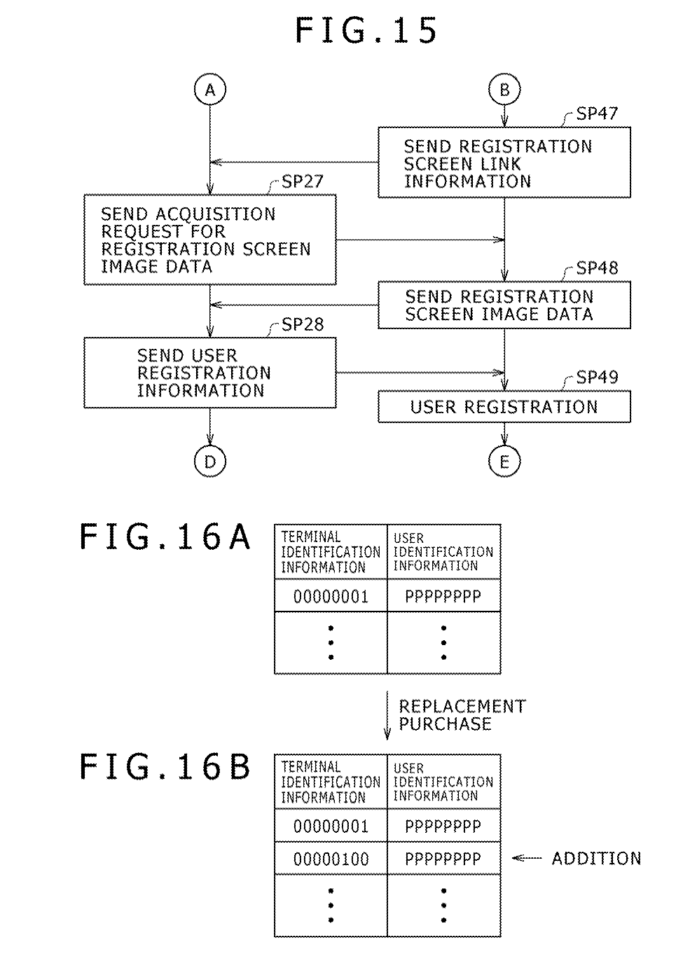

Now, the second history information storage processing procedure is described in accordance with the sequence chart illustrated in FIGS. 14 and 15. If one of pieces of presentation information displayed based on the providing information RE is designated by the user, then the control section 20 of the information presentation terminal 12 sends, at step SP20, an acquisition request for detailed information, to which presentation identification information BD corresponding to the designated presentation information and terminal identification information are added, from the sender section 24 to the information providing apparatus 11 through the network NT. Incidentally, if authentication identification information is temporarily stored in the authentication information storage section 27 at this time, then the control section 20 adds also the authentication identification information to the acquisition request for detailed information.

When the acquisition request for detailed information sent from the information presentation terminal 12 is received by the receiver section 14, the control section 13 of the information providing apparatus 11 controls the authentication processing section 18 to perform an authentication process for the reproduction section 22 based on the acquisition request at step SP40. Thereafter, the processing advances to step SP41, at which the control section 13 decides whether or not the information presentation terminal 12 is authenticated as a result of the authentication process by the authentication processing section 18. If an affirmative result is obtained at step SP41, then the control section 13 recognizes that the information presentation terminal 12 is authenticated as being owned by a regular user, whereafter the processing advances to step SP42.

On the other hand, if a negative result is obtained at step SP41, then the control section 13 recognizes that the information presentation terminal 12 is not authenticated, whereafter the processing advances to step SP43. At step SP43, the control section 13 sends authentication error notification information from the sender section 16 to the information presentation terminal 12 through the network NT.

The control section 20 of the information presentation terminal 12 decides at step SP21 whether or not authentication error notification information is received from the information providing apparatus 11. If an affirmative result is obtained at step SP21, then this signifies that the information presentation terminal 12 is not authenticated, and the processing advances to step SP22. At step SP22, the control section 20 decides whether or not a nickname is stored in the authentication information storage section 27.

If an affirmative result is obtained at step SP22, then this signifies that the user of the information presentation terminal 12 is stored already as a regular user, and the control section 20 advances the processing to step SP23. At step SP23, the control section 20 decides whether or not user identification information and a password are stored in the authentication information storage section 27. If an affirmative result is obtained at step SP23, then the control section 20 advances the processing to step SP24.

On the other hand, if a negative result is obtained at step SP23, then this signifies that, although a nickname is stored in the authentication information storage section 27, user identification information and a password are not stored. At this time, the control section 20 advances the processing to step SP25. At step SP25, the control section 20 urges the user to input user identification information and a password through the display section 26. Then, if user identification information and a password are inputted in accordance with the urging, then the processing advances to step SP24.

At step SP24, the control section 20 sends an authentication request, to which the nickname, user identification information and password are added, from the sender section 24 to the information providing apparatus 11 through the network NT.

On the other hand, if a negative result is obtained at step SP22, then since a nickname is not stored in the information presentation terminal 12, this signifies that the user of the information presentation terminal 12 is an unregistered user. At this time, the control section 20 advances the processing to step SP26, at which it sends an authentication request, to which none of a nickname, user identification information and a password is added, from the sender section 24 to the information providing apparatus 11 through the network NT.

When the authentication request sent from the information presentation terminal 12 is received by the receiver section 14, the control section 13 of the information providing apparatus 11 decides at step SP44 whether or not a nickname is added to the authentication request. If an affirmative result is obtained at step SP44, then this signifies that there is the possibility that the user of the information presentation terminal 12 from which the authentication request is received may be registered as a regular user. At this time, the control section 13 advances the processing to step SP45.

At step SP45, the control section 13 controls the authentication processing section 18 to perform an authentication process of the information providing apparatus 11 based on the authentication request. Thereafter, the processing advances to step SP46, at which the control section 13 decodes whether or not the information presentation terminal 12 is authenticated as a result of the authentication process by the authentication processing section 18. If an affirmative result is obtained at step SP46, then the control section 13 recognizes that the information presentation terminal 12 is authenticated as being owned by a regular user, whereafter the processing advances to step SP42.

On the other hand, if a negative result is obtained at step SP46, then this signifies that at least one of the nickname, user identification information and password added to the authentication request is wrong. At this time, the processing advances to step SP43, at which the control section 13 sends authentication error notification information to the information presentation terminal 12 again.

Further, if a negative result is obtained at step SP44, then this signifies that, since an authentication request to which no nickname is added is sent from the information presentation terminal 12, the user of the information presentation terminal 12 is an unregistered user. At this time, the control section 13 advances the processing to step SP47 illustrated in FIG. 15. Referring to FIG. 15, at step S47, the control section 13 sends registration screen image link information corresponding to the registration screen RS from the sender section 16 to the information presentation terminal 12 through the network NT.

When the registration screen image link information is received by the receiver section 25, the control section 20 of the information presentation terminal 12 sends, at step S27, an acquisition request for registration screen image data from the sender section 24 to the information providing apparatus 11 through the network NT based on the registration screen image link information.

When the control section 13 of the information providing apparatus 11 receives the acquisition request for registration screen image data sent from the information presentation terminal 12 by means of the receiver section 14, the control section 13 sends, at step S48, registration screen image data read out from the registration information storage section 15 in accordance with the acquisition request from the sender section 16 to the information presentation terminal 12 through the network NT.

When the control section 20 of the information presentation terminal 12 receives the registration screen image data sent from the information providing apparatus 11 through the receiver section 25, the control section 20 controls the display section 26 to display the registration screen RS based on the registration screen image data to urge the user to input its user information, password and nickname. If user information, a password and a nickname are inputted in accordance with the urging, then the control section 20 sends the inputted user identification information, password and nickname as user registration information from the sender section 24 to the information providing apparatus 11 through the network NT at step SP28. Thereafter, the processing returns to step SP20 illustrated in FIG. 14.

When the control section 13 of the information providing apparatus 11 receives the user registration information sent from the information presentation terminal 12 through the receiver section 14, the control section 13 controls the user registration section 17 to store the user registration information into the registration information storage section 15 thereby to perform user registration of the user of the information presentation terminal 12 at step SP49. Thereafter, the processing returns to step SP40.

It is to be noted that, if a negative result is obtained at step SP21 described hereinabove with reference to FIG. 14, then this signifies that the information presentation terminal 12 is authenticated based on the acquisition request for detailed information sent to the information providing apparatus 11. At this time, the control section 20 omits the processes at steps SP22, SP23, SP24, SP25, SP26, SP27 and SP28 described hereinabove.

At step SP42 to which the processing advances finally as a result of authentication of the information presentation terminal 12 at step SP41 or SP46 as described hereinabove, the control section 13 of the information providing apparatus 11 controls the user registration section 17 to decide whether or not the terminal identification information (added to the authentication request for detailed information) of the information presentation terminal 12 authenticated as described above and the user identification information are already in a linked state with each other. In this instance, the user registration section 17 decides whether or not the terminal identification information of the information presentation terminal 12 and the user identification information are already linked with each other depending upon whether or not the terminal identification information of the information presentation terminal 12 is stored in a matched relationship with the user identification information in the history information storage section 102.

If a negative result is obtained at step SP42, then this signifies that the terminal identification information of the information presentation terminal 12 and the user identification information are not linked with each other as yet. At this time, the processing advances to step SP50, at which the control section 13 controls the user registration section 17 to store the terminal identification information of the information presentation terminal 12 in a matched relationship with the user identification information into the history information storage section 102 thereby to link the terminal identification information of the information presentation terminal 12 and the user identification information with each other. Thereafter, the processing advances to step SP51.

On the other hand, if an affirmative result is obtained at step SP42, then the control section 13 directly advances the processing to step SP51 while omitting linking between the terminal identification information of the information presentation terminal 12 and the user identification information.

At step SP51, the control section 13 sends the detailed link information of the presentation identification information BD added to the acquisition request for detailed information sent from the information presentation terminal 12 from the sender section 16 to the information presentation terminal 12 through the network NT. Further, at step SP51, the control section 13 controls the history information management section 101 to produce history information (which describes the terminal identification information and the user identification information) indicating that an acquisition request for detailed information is received from the information presentation terminal 12. Then, the control section 13 stores the produced history information into the history information storage section 102.

When the control section 20 of the information presentation terminal 12 receives the detailed link information sent from the information providing apparatus 11 through the receiver section 25, then it sends, at step SP29, an acquisition request for screen image data of detailed information based on the detailed link information from the sender section 24 to the information providing apparatus 11 through the network NT.

When the acquisition request for screen image data of detailed information sent from the information presentation terminal 12 is received through the receiver section 14, the control section 13 of the information providing apparatus 11 sends, at step SP52, screen image data of the detailed information read out from the detailed information storage section 29 in accordance with the acquisition request from the sender section 16 to the information presentation terminal 12 through the network NT.

If, upon user registration, the user identification information and the terminal identification information of the information presentation terminal 12 of a user who is registered as a regular user are linked with each other in accordance with such a history information storage processing procedure as described above, or if any request is sent from the information presentation terminal 12 to the information providing apparatus 11, then the control section 13 of the information providing apparatus 11 stores the history information into the history information storage section 102 every time.

### 1-5. Operation and Effects of the First Embodiment

The terminal registration section 100 of the information providing apparatus 11 having the configuration described above applies terminal identification information to each of information presentation terminals 12 connected to the information providing apparatus 11 through the network NT and sends the terminal identification information to the information presentation terminal 12.

Then, when any request (an acquisition request for terminal identification information, an acquisition request for providing information RE or the like) sent from any information presentation terminal 12 connected through the network NT and having the terminal identification information added thereto is received, the history information management section 101 of the information providing apparatus 11 stores this as history information matched with the terminal identification information into the history information storage section 102.

As a result, the information providing apparatus 11 can manage, for each information presentation terminal 12, the operation history of the information presentation terminal 12 even if user registration of the user of the information presentation terminal 12 is not completed as yet.

If the user registration section 17 of the information providing apparatus 11 thereafter registers the user of the information presentation terminal 12 as a regular user in accordance with a request from the information presentation terminal 12, then the user identification information registered as user registration information of the user (that is, a regular user) and the terminal identification information applied to the information presentation terminal 12 of the user are stored in a matched relationship with each other into the history information storage section 102.

As a result, the information providing apparatus 11 can specify history information prior to user registration of a user who has a user registration from among the pieces of history information prior to user registration stored in the history information storage section 102.

Further, if any request (an acquisition request for detailed information or the like) sent from the information presentation terminal 12 of the user after the user registration and having the terminal identification information applied thereto is received, then the history information management section 101 of the information providing apparatus 11 stores this as history information matched with the terminal identification information and the user identification information into the history information storage section 102.

As a result, the information providing apparatus 11 can manage, for each information presentation terminal 12, the operation history of the information presentation terminal 12 continuously also after user registration.

In particular, the information providing apparatus 11 can manage registration information before user registration and registration information after user registration in a concentrated fashion based on terminal identification information. Further, based on the history information managed in a concentrated fashion in this manner, the information providing apparatus 11 can recognize the substance and the time of issuance of the request from each information presentation terminal 12 before its user registration and the substance and the time of issuance of the request for information from each information presentation terminal 12 after its user registration.

The information providing apparatus 11 having the configuration described above can identify the information presentation terminal 12 of any user also before user registration by applying terminal identification information to the information presentation terminal 12 connected thereto through the network NT. Further, the information providing apparatus 11 can manage history information for each information presentation terminal 12 of each user even before user registration by storing the terminal identification information and the history information in a matched relationship with each other. Furthermore, by matching user identification information and terminal identification information with each other when user registration is performed, the user identification and the history information before user registration can be matched with each other. Consequently, the history information before user registration can be utilized effectively also after user registration.

### 2. Second Embodiment

Now, an information processing apparatus according to a second embodiment of the present invention is described. The information processing apparatus of the present embodiment is a modification to but is different from that of the first embodiment in that it has an additional function to the history information management function. Further, a similar history information management processing procedure is applied in the second embodiment.

More particularly, in the second embodiment of the present invention, for example, when a user purchases an information presentation terminal 12 for replacement, a function of taking over history information of the information presentation terminal 12 before the purchase replacement as history information of the information presentation terminal 12 after the purchase replacement is added to the history information management function. In this regard, the information processing apparatus of the second embodiment is different from that of the first embodiment.

### 2-1. Taking Over of History Information

Here, taking over of history information according to the second embodiment is described. It is to be noted here that the following description is given taking a case wherein, after a user performs user registration using a first information presentation terminal 12, it purchases and uses a second information presentation terminal 12 in place of the first information presentation terminal 12.

As described hereinabove in connection with the information processing apparatus of the first embodiment, if the first information presentation terminal 12 is connected to the information providing apparatus 11 through the network NT, then the information providing apparatus 11 applies terminal identification information (for example, “00000001”) to the first information presentation apparatus 11 using the terminal registration section 100 and sends it to the first information presentation terminal 12. Then, when any request sent from the first information presentation terminal 12 and having the terminal identification information applied thereto is received, the history information management section 101 stores such reception of the request as information matched with the terminal identification information into the history information storage section 102.

Thereafter, the information providing apparatus 11 registers the user of the first information presentation terminal 12 as a regular user in accordance with a request from the first information presentation terminal 12. Then, the user registration section 17 stores the user identification information (for example, “PPPPPPPP”) and the terminal identification information (for example, “00000001”) applied to the first information presentation terminal 12 in a matched relationship with each other into the history information storage section 102 as seen in FIG. 16A.

Also after user registration, if any request sent from the first information presentation terminal 12 and having the terminal identification information added thereto is received, then the information providing apparatus 11 stores this as history information matched with the terminal identification information (for example, “00000001”) of the first information presentation terminal 12 and the user identification information (for example, “PPPPPPPP”) into the history information storage section 102 by means of the history information management section 101.

At this point of time, the terminal identification information of the first information presentation terminal 12 and the user identification information of the user of the first information presentation terminal 12 are stored in a matched relationship with each other in the history information storage section 102 of the information providing apparatus 11. Further, the history information before the user registration and the history information after the user registration of the information presentation terminal 12 are stored as history information of the information presentation terminal 12 in the history information storage section 102.

Here, if the user purchases a second information presentation terminal 12 in place of the first information presentation terminal 12 and connects the second information presentation terminal 12 in place of the first information presentation terminal 12 to the network NT, then the information providing apparatus 11 applies terminal identification information (for example, “00000100”) to the second information presentation terminal 12 by means of the terminal registration section 100 and sends the applied terminal identification information to the information presentation terminal 12.

Further, for example, if user registration information is inputted through the second information presentation terminal 12 and the information providing apparatus 11 recognizes that the user of the second information presentation terminal 12 already has a user registration, then the information providing apparatus 11 stores the user identification information (for example, “PPPPPPPP”) of the user and the terminal identification information (for example, “00000100”) applied to the second information presentation terminal 12 in a matched relationship with each other into the history information storage section 102 by means of the user registration section 17.

Thereafter, if any request sent from the second information presentation terminal 12 and having the terminal identification information applied thereto is received, then the information providing apparatus 11 stores this as history information matched with the terminal identification information (for example, “00000100”) of the second information presentation terminal 12 and the user identification information (for example, “PPPPPPPP”) into the history information storage section 102 by means of the history information management section 101.

In this manner, if the user uses the first information presentation terminal 12 to perform user registration and purchases and uses the second information presentation terminal 12 in place of the first information presentation terminal 12, the information providing apparatus 11 stores, at a point of time when the user uses the first information presentation terminal 12 to perform user registration, the terminal identification information (for example, “00000001”) of the first information presentation terminal 12 and the user identification information (for example, “PPPPPPPP”) of the user of the first information presentation terminal 12 in a matched relationship with each other into the history information storage section 102.

Then, when the user changes over the terminal to be used by the user from the first information presentation terminal 12 to the second information presentation terminal 12, then the information providing apparatus 11 stores the terminal identification information (for example, “00000100”) of the second information presentation terminal 12 and the user identification information (for example, “PPPPPPPP”) of the user of the second information presentation terminal 12 in a matched relationship with each other into the history information storage section 102.

Consequently, the information providing apparatus 11 can recognize that the information presentation terminal 12 having the terminal identification information matched with the same user identification information is an information presentation terminal 12 of the same user. Therefore, the information providing apparatus 11 can recognize also that, for example, the user who uses the second information presentation terminal 12 has used the first information presentation terminal 12 formerly.

Accordingly, the information providing apparatus 11 can manage the history information of the first information presentation terminal 12 stored in the history information storage section 102 as the history information of the second information presentation terminal 12. Therefore, the history information of the first information presentation terminal 12 can be taken over as the history information of the second information presentation terminal 12, and consequently, the history information of the information presentation terminal 12 before the purchase replacement can be utilized effectively as the history information of the information presentation terminal 12 after the purchase replacement.

### 3. Third Embodiment

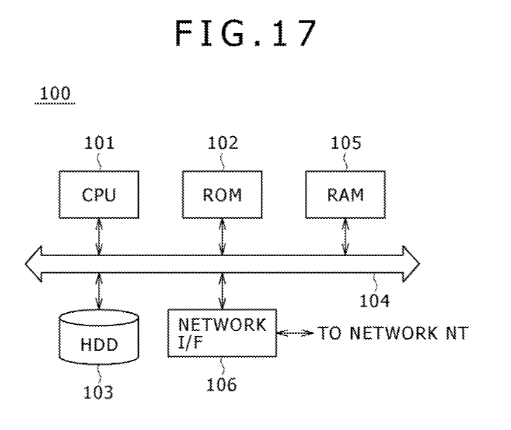

Now, a third embodiment of the present invention is described. An information processing apparatus 100 shown in FIG. 17 is an example wherein the information processing apparatus 1 having the configuration described hereinabove with reference to FIG. 1 is implemented by a hardware configuration. In particular, the information processing apparatus 100 includes a CPU 101 for generally controlling the entire apparatus. To this end, the CPU 101 suitably develops various programs such as a basic program, an application program and so forth stored in advance in a ROM 102 or a hard disk drive 103 into a RAM 105 through a bus 104 and execute the programs thereby to execute various processes.

The hard disk drive 103 is configured such that not only such various programs as described above but also various kinds of information such as information to be provided to a terminal (not shown) connected thereto through the network NT, information received from the terminal and so forth are stored therein.

In particular, if an acquisition request for desired information sent from a terminal connected through the network NT is received through a network interface 106, then the CPU 101 reads out information corresponding to the acquisition request from the hard disk drive 103 and sends the read out information to the terminal through the network interface 106. Further, if information sent from the terminal is received through the network interface 106, then the CPU 101 stores this into the hard disk drive 103.

In the information processing apparatus 100, the CPU 101 is capable of executing the various processes by software in accordance with the various programs stored in the ROM 102 or the hard disk drive 103. Therefore, by suitably selecting various programs to be stored in the ROM 102 or the hard disk drive 103 in accordance with the various functions (in particular, processes to be executed) of the information processing apparatus 1 (FIG. 1) of the functional block configuration described above, the CPU 101 can function similarly to the terminal registration section 2, history information management section 6, information selection section 7 and user registration section 8 of the information processing apparatus 1. Further, the RAM 105 and the hard disk drive 103 can function similarly to the storage section 5 of the information processing apparatus, and the network interface 106 can function similarly to the sender section 3 and receiver section 4 of the information processing apparatus 1.

Therefore, in the information processing apparatus 100, the various functions of the information processing apparatus 1 can be implemented by the configuration of the apparatus 100 itself, and the effects similar to those of the first and second embodiments can be anticipated.

It is to be noted that, while the case is described in the third embodiment wherein the CPU 101 executes the processes based on the various functions of the information processing apparatus 1 in accordance with the various programs stored in advance in the ROM 102 or the hard disk drive 103, the present invention is not limited to this. For example, the various programs may be recorded in advance on a recording media such as a CD, a DVD or the like and the CPU 101 may execute the processes based on the various functions of the information processing apparatus 1 in accordance with the various programs read out from the recording media, and the various program may be installed from the recording media into the hard disk drive 103. Further, the various programs may be acquired from the outside through the network interface 106.

### 4. Other Embodiments

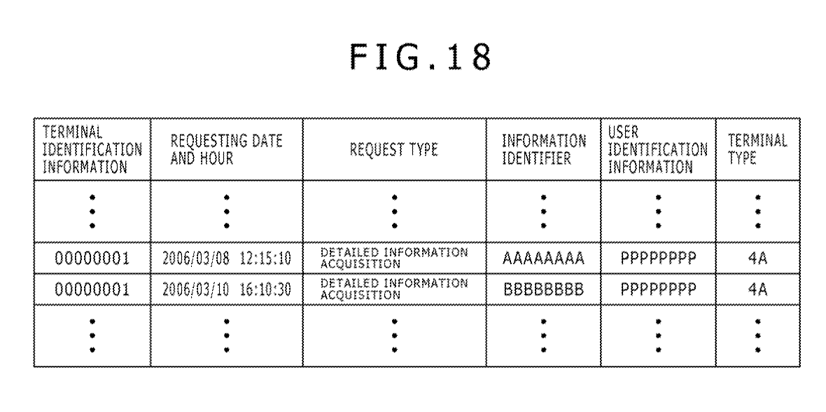

It is to be noted that, while the case is described in the first and second embodiments wherein the history information is composed of terminal identification information of the information presentation terminal 12 from which a request is sent, the date and hour at which the request is sent, a kind of the request received, an identifier (presentation identification information BD of presentation information) of information to be acquired by the information presentation terminal 12 in accordance with the request, and user identification information of the information presentation terminal 12 from which the request is sent, the present invention is not limited to this. For example, as shown in FIG. 18, a type (for example, “4A”) of the information presentation terminal 12 from which the request is set may be added to the history information, and the history information may be configured using several kinds of information including information useful for providing information to a user of the information presentation terminal 12 such as a free capacity of the data storage section 23 of the information presentation terminal 12 and so forth.

Further, while the case is described in the first and second embodiments wherein, when a request such as an acquisition request for terminal identification information, a notification that terminal identification information is stored (also such notification is considered as a request), an acquisition request for providing information RE or an acquisition request for detailed information is received from the information presentation terminal 12, the history information management section 101 of the information providing apparatus 11 produces history information which indicates this and stores the produced information into the history information storage section 102, the present invention is not limited to this. For example, in a case wherein various requests such as an authentication request, an acquisition request for registration screen image data, user registration information (also this is considered as a request) and so forth are received from the information presentation terminal 12, history information which indicates this may be produced and stored into the history information storage section 102. Further, a notification issued from the information providing apparatus 11 as in a case that, for example, authentication error notification information is received from the information providing apparatus 11 or in a like case may be stored as history information into the history information storage section 102.

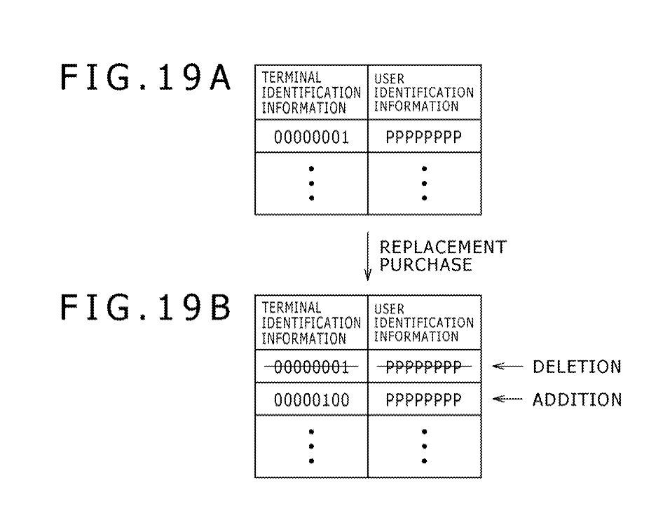

Further, in the second embodiment described hereinabove, when a user uses the first information presentation terminal 12 to perform user registration, the terminal identification information of the first information presentation terminal 12 and the user identification information of the user are stored in a matched relationship with each other into the history information storage section 102. Then, if the user changes over the terminal to be used by the user from the first information presentation terminal 12 to the second information presentation terminal 12, then the terminal identification information of the second information presentation terminal 12 and the user identification information of the user are stored in a matched relationship with each other into the history information storage section 102. However, according to the present invention, the process upon such changeover is not limited to this, but may be performed in the following manner. In particular, after the terminal identification information of the first information presentation terminal 12 and the user identification information of the user are stored in a matched relationship with each other into the history information storage section 102, if, upon changeover of the terminal to be used by the user from the first information presentation terminal 12 to the second information presentation terminal 12, the terminal identification information of the second information presentation terminal 12 and the user identification information of the user are stored in a matched relationship with each other separately into the history information storage section 102, whereafter the terminal identification information of the first information presentation terminal 12 stored in a matched relationship with the user identification information of the user in the history information storage section 102 is deleted and then the history information stored in a matched relationship with the terminal identification information of the first information presentation terminal 12 is updated so as to match with the terminal identification information of the second information presentation terminal 12 as seen from FIGS. 19A and 19B. For example, the terminal identification information of the history information of the first information presentation terminal 12 is rewritten from “00000001”into “00000100”which is the terminal identification information of the second information presentation terminal 12.

By such a process as described above, only the terminal identification information of the second information presentation terminal can be used to manage the history information used when the first information presentation terminal is used as the history information of the second information presentation terminal.

Further, while, in the first and second embodiments described hereinabove, the presentation information includes a presentation character string and a presentation image, according to the present invention, the presentation information is not limited to this but may include only characters or only an image.

Further, while, in the first and second embodiments described hereinabove, a plurality of pieces of presentation use information BU1 to BUN are placed in the providing information RE, according to the present invention, the use information to be placed in the providing information RE is not limited to this, but one piece of presentation use information may be placed in the providing information RE or the presentation information itself may be placed in the providing information RE. Or else, the providing information RE may be prepared for each of a plurality of types of presentation information, that is, for each of the presentation identification information BK.

In particular, a plurality of pieces of providing information RE are stored individually, for example, for different types of presentation information, that is, for individual pieces of the presentation identification information BK, in the providing information storage section 28 of the information providing apparatus 11. Then, the information providing apparatus 11 sends a list of the providing information RE to the information presentation terminal 12, and the information presentation terminal 12 receiving the list sends an acquisition request for a desired one of the pieces of providing information RE designated by the user from within the list to the information providing apparatus 11. Consequently, the information presentation terminal 12 can present presentation information of the type in which the user is interested to the user.

Further, in this instance, if the information providing apparatus 11 writes the type of the providing information RE requested for acquisition from the information presentation terminal 12 into and stores the history information, then also before user registration, the information providing apparatus 11 can recognize in what type of presentation information the user of the information presentation terminal 12 is interested. Thus, if the history information is utilized effectively after the user registration, then presentation information further suitable for the user can be presented.

Further, while, in the first and second embodiments described hereinabove, the information presentation terminal 12 presents all presentation information included in the providing information RE to the user, according to the present invention, the presentation is not limited to this, but the information presentation terminal 12 may selectively present presentation information of a type designated by the user based on the presentation identification information BK.

Furthermore, while, in the first and second embodiments described hereinabove, the information presentation terminal 12 displays detailed information as the detailed information screen image 90 to present the detailed information to the user, according to the present invention, the presentation of detailed information is not limited to this, but, for example, detailed information may be displayed together with some other information such as function execution information so as to be presented to the user.

Further, the present invention not only can be applied to the information processing apparatus 1, information providing apparatus 11 and terminal registration section 100 described hereinabove in connection with the first to third embodiments of the present invention but also can be applied widely to various information processing apparatus such as a personal computer and a server.

The present invention can be applied to an information providing apparatus such as a server which provides information relating to contents.

While preferred embodiments of the present invention have been described using specific terms, such description is for illustrative purposes only, and it is to be understood that changes and variations may be made without departing from the spirit or scope of the following claims.

What is claimed is:

1. An information processing apparatus comprising:
terminal registration means configured to apply terminal identification information to a terminal connected through a network;
sender means configured to send the terminal identification information to the terminal;
receiver means configured to receive a request from the terminal together with the terminal identification information;
history information management means configured to store and manage, if said receiver means receives the information acquisition request from the terminal together with the terminal identification information, an effect that the information acquisition request is received as history information in a matched relationship with the received terminal identification information into storage means;
information selection means configured to select information to be sent to the terminal based on the information acquisition request; and
user registration means configured to register, if said receiver means receives a user registration request from the terminal together with the terminal identification information, the user identification information of a user of the terminal and store the user identification information and the terminal identification information received from the terminal in a matched relationship with each other into said storage means.

2. The information processing apparatus according to claim 1, wherein said history information management means stores also an effect that the terminal identification information is applied as the history information into said storage means.

3. The information processing apparatus according to claim 1, wherein said history information management means stores, as the history information, also the date and time at which the information acquisition request is received and the substance of information requested by the information acquisition request into said storage means.

4. The information processing apparatus according to claim 1, wherein
said information selection means selects information to be sent to the terminal based on the history information matched with the user identification information stored in said storage means, and
said sender means sends the information selected by said information selection means to the terminal.

5. The information processing information according to claim 1, wherein
if said receiver means receives user identification information same as the user identification information matched with first terminal identification information stored in a matched relationship with the user identification information in said storage means from a terminal to which second terminal identification information different from the first terminal identification information is applied, then said user registration means stores the received user identification information in a matched relationship with the second terminal identification information into said storage means, and
if said receiver means receives the information acquisition request together with the second terminal identification information from the terminal to which the second terminal identification information is applied, then said history information management means stores an effect that the information acquisition request is received as history information in a matched relationship with the received second terminal identification information into said storage means.

6. The information processing apparatus according to claim 5, wherein, after the user identification information and the second terminal identification information are stored in a matched relationship with each other into said storage means, said user registration means deletes the first terminal identification information stored in a matched relationship with the user identification information in said storage means and matches the history information stored in a matched relationship with the first terminal identification information in said storage means with the second terminal identification information.

7. An information processing method comprising the steps of:
applying terminal identification information to a terminal connected through a network;
sending the terminal identification information applied at the terminal registration step to the terminal;
storing, if an information acquisition request from the terminal is received together with the terminal identification information, an effect that the information acquisition request is received as history information in a matched relationship with the received terminal identification information into storage means;
selecting information to be sent to the terminal based on the information acquisition request; and
registering, if a user registration request from the terminal is received together with the terminal identification information, the user identification information of the user of the terminal and store the user identification information and the terminal identification information received from the terminal in a matched relationship with each other into said storage means.

8. The information processing method according to claim 7, wherein, at the history information storage step, also the date and time at which the information acquisition request is received and the substance of information requested by the information acquisition request are stored as the history information into said storage means.

9. The information processing method according to claim 7, wherein
at the information selection step, information to be sent to the terminal is selected based on the history information matched with the user identification information stored in said storage means, and
at the sending step, the selected information is sent to the terminal.

10. The information processing method according to claim 7, wherein
at the user registration step, if user identification information same as user identification information matched with first terminal identification information stored in a matched relationship with the user identification information in said storage means is received from a terminal to which second terminal identification information different from the first terminal identification information is applied, then the received user identification information and the second terminal identification information are stored in a matched relationship with each other into said storage means, and
at the history information management step, if the information acquisition request is received together with the second terminal identification information from the terminal to which the second terminal identification information is applied, then an effect that the information acquisition request is received is stored as history information in a matched relationship with the received second terminal identification information into said storage means.

11. The information processing method according to claim 10, wherein, at the user registration step, after the user identification information and the second terminal identification information are stored in a matched relationship with each other into said storage means, then the first terminal identification information stored in a matched relationship with the user identification information in said storage means is deleted and the history information stored in a matched relationship with the first terminal identification information in said storage means is matched with the second terminal identification information.

12. An information processing program for making a computer to execute an information processing comprising the steps of:
applying terminal identification information to a terminal connected through a network;
sending the terminal identification information applied at the terminal registration step to the terminal;
storing, if an information acquisition request from the terminal is received together with the terminal identification information, an effect that the information acquisition request is received as history information in a matched relationship with the received terminal identification information into storage means;
selecting information to be sent to the terminal based on the information acquisition request; and
registering, if a user registration request from the terminal is received together with the terminal identification information, the user identification information of the user of the terminal and store the user identification information and the terminal identification information received from the terminal in a matched relationship with each other into said storage means.

13. The information processing program according to claim 12, wherein, at the history information storage step, also the date and time at which the information acquisition request is received and the substance of information requested by the information acquisition request are stored as the history information into said storage means.

14. The information processing program according to claim 12, wherein
at the information selection step, information to be sent to the terminal is selected based on the history information matched with the user identification information stored in said storage means, and
at the sending step, the selected information is sent to the terminal.

15. The information processing program according to claim 12, wherein
at the user registration step, if user identification information same as user identification information matched with first terminal identification information stored in a matched relationship with the user identification information in said storage means is received from a terminal to which second terminal identification information different from the first terminal identification information is applied, then the received user identification information and the second terminal identification information are stored in a matched relationship with each other into said storage means, and
at the history information management step, if the information acquisition request is received together with the second terminal identification information from the terminal to which the second terminal identification information is applied, then an effect that the information acquisition request is received is stored as history information in a matched relationship with the received second terminal identification information into said storage means.

16. The information processing program according to claim 15, wherein, at the user registration step, after the user identification information and the second terminal identification information are stored in a matched relationship with each other into said storage means, then the first terminal identification information stored in a matched relationship with the user identification information in said storage means is deleted and the history information stored in a matched relationship with the first terminal identification information in said storage means is matched with the second terminal identification information.

17. An information processing apparatus, comprising:
a terminal registration section configured to apply terminal identification information to a terminal connected through a network;
a sender section configured to send the terminal identification information to the terminal;
a receiver section configured to receive a request from the terminal together with the terminal identification information;
a history information management section configured to store and manage, if said receiver section receives the information acquisition request from the terminal together with the terminal identification information, an effect that the information acquisition request is received as history information in a matched relationship with the received terminal identification information into a storage section;
an information selection section configured to select information to be sent to the terminal based on the information acquisition request; and
an user registration section configured to register, if said receiver section receives a user registration request from the terminal together with the terminal identification information, the user identification information of a user of the terminal and store the user identification information and the terminal identification information received from the terminal in a matched relationship with each other into said storage section.
